(19) United States
(12) Patent Application Publication
(10) Pub. No.: US 2025/0371070 A1
(43) Pub. Date: Dec. 4, 2025

(54) METHOD AND DEVICE FOR PROVIDING SIMILAR CONTENT IN CONTENT STREAMING SYSTEM

(71) Applicant: TVING CO., LTD., Seoul (KR)

(72) Inventors: Dong Hwan KIM, Yongin (KR); Chan Hyeong JOO, Gimpo (KR)

(21) Appl. No.: 19/299,398

(22) Filed: Aug. 14, 2025

Related U.S. Application Data
(63) Continuation of application No. PCT/KR2023/019146, filed on Nov. 24, 2023.

(30) Foreign Application Priority Data
Feb. 15, 2023 (KR) 10-2023-0020228
Feb. 24, 2023 (KR) 10-2023-0025139
Sep. 6, 2023 (KR) 10-2023-0118096

(51) Int. Cl. G06F 16/48; G06F 16/438

(52) U.S. Cl. CPC G06F 16/48; G06F 16/4387

(57) ABSTRACT

Provided are a method and device for providing similar content in a content streaming system. A method of operating a server in a content streaming system may comprise obtaining first sequence-type text data including information included in first metadata of a first content item, obtaining second sequence-type text data including information included in second metadata of a second content item, determining a first vector corresponding to the first sequence-type text data and a second vector corresponding to the second sequence-type text data using a language model learned based on synopsis information included in metadata of content items, determining similarity between the first content item and the second content item using the first vector and the second vector, and providing a content list including at least one content item including the second content item selected based on the similarity.

### CROSS-REFERENCE TO RELATED APPLICATION

The present application is a Continuation Application based on International Application No. PCT/KR2023/019145, filed on Nov. 23, 2023, which claims priority to a Korean patent application No. 10-2023-0020228, filed Feb. 15, 2023, a Korean patent application No. 10-2023-0025139, filed Feb. 24, 2023, and a Korean patent application No. 10-2023-0118096, filed Sep. 6, 2023, the entire contents of which are incorporated herein for all purposes by this reference.

### TECHNICAL FIELD

The present disclosure relates to a content streaming system, and more particularly, to a method and device for providing similar content in a content streaming system.

### BACKGROUND

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### SUMMARY

The present disclosure can provide a method and device for effectively providing similar content in a content streaming system.

The present disclosure can provide a method and device for recommending content similar to specific content in a content streaming system.

The present disclosure can provide a method and device for determining similar content using a language model in a content streaming system.

The present disclosure can provide a method and device for recommending content based on text metadata describing the details of content in a content streaming system.

The present disclosure can provide a method and device for learning a language model based on a hashtag of content.

The present disclosure can provide a method and device for learning a language model based on a genre of content.

The present disclosure can provide a method and device for learning a language model based on a synopsis of content.

The present disclosure can provide a method and device for performing two-step learning for a language model based on two different types of information among text metadata of content.

The present disclosure can provide a method and device for determining similarity between contents using a language model learned using text metadata of content.

The technical problems solved by the present disclosure are not limited to the above technical problems and other technical problems which are not described herein will become apparent to those skilled in the art from the following description.

A method of operating a server in a content streaming system according to an example of the present disclosure may comprise obtaining first sequence-type text data including information included in first metadata of a first content item, obtaining second sequence-type text data including information included in second metadata of a second content item, determining a first vector corresponding to the first sequence-type text data and a second vector corresponding to the second sequence-type text data using a language model learned based on synopsis information included in metadata of content items, determining a similarity between the first content item and the second content item using the first vector and the second vector, and providing a content list including at least one content item including the second content item selected based on the similarity.

According to an example of the present disclosure, the language model may be learned through training to predict synopsis information of the content items based on a masked language model (MLM).

According to an example of the present disclosure, the language model may be primarily learned through training to predict hashtag information of the content items based on the MLM and may be secondarily learned through training to predict synopsis information of the content items based on the MLM.

According to an example of the present disclosure, the language model may be primarily learned through training to predict synopsis information of the content items based on the MLM and may be secondarily learned through training to predict hashtag information of the content items based on the MLM.

According to an example of the present disclosure, the language model may be learned through training to predict a masked token located between tokens indicating a synopsis area among a plurality of tokens included in input sequence-type text data.

According to an example of the present disclosure, tokens indicating the synopsis area may include at least one of a separator token for separating different types of features or a special token for different types of features other than the synopsis.

According to an example of the present disclosure, the method may further comprise converting text metadata describing contents of the content items into the sequence-type text data, masking a synopsis token located between tokens indicating the synopsis area among a plurality of tokens included in the sequence-type text data, and performing learning on the language model through training to predict the masked synopsis token, and the text metadata may include at least one of title, synopsis, genre, director, actor or hashtag information.

According to an example of the present disclosure, the converting the text metadata into the sequence-type text data may comprise dividing the text metadata into a plurality of tokens, and generating the sequence-type text data by inserting at least one separator between the tokens, and the at least one separator may further include at least one of tokens indicating the synopsis area, a separator token for separating different types of features, or special tokens indicating an area of a specific type of feature.

According to an example of the present disclosure, the masking the synopsis token may comprise selecting an independent token from among synopsis tokens located between tokens indicating the synopsis area and masking the selected independent token, and the independent token may be a token that does not start with a specified symbol.

According to an example of the present disclosure, the training may be performed using a prediction model, and the prediction model may include the language model that receives, as input, sequence-type text data including the masked synopsis token and outputs vector values corresponding to the sequence-type text data, and a masked language model (MLM) head layer configured to predict at least one input token corresponding to at least one vector value output from the language model.

According to an example of the present disclosure, the determining the similarity between the first content item and the second content item may comprise calculating a similarity between the first vector and the second vector using a cosine similarity algorithm, and each of the first vector and the second vector may be obtained by performing average pooling for output vector values of a last hidden layer of the learned language model.

According to an example of the present disclosure, each of the first vector and the second vector may be determined by assigning a weight to a vector value corresponding to a position of a specified feature among the output vector values of the last hidden layer of the learned language model.

According to an example of the present disclosure, the method may further comprise obtaining third sequence-type text data including information included in third metadata of a third content item, determining a third vector corresponding to the third sequence-type text data using the learned language model, and determining a similarity between the first content item and the third content item using the first vector and the third vector, and the providing the content list may comprise selecting the second content item from among the second content item and the third content item based on the similarity between the first content item and the second content item and the similarity between the first content item and the third content item.

A server in a content streaming system according to an embodiment of the present disclosure may comprise a communication unit configured to transmit and receive signals to and from at least one client device and a processor electrically connected to the communication unit. The processor may obtain first sequence-type text data including information included in first metadata of a first content item, obtain second sequence-type text data including information included in second metadata of a second content item, determine a first vector corresponding to the first sequence-type text data and a second vector corresponding to the second sequence-type text data using a language model learned based on synopsis information included in metadata of content items, determine a similarity between the first content item and the second content item using the first vector and the second vector, and provide a content list including at least one content item including the second content item selected based on the similarity.

A program stored in a recording medium according to an embodiment of the present disclosure may execute the above-described method when operated by a processor.

According to the present disclosure, similar content to reference content can be recommended.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF THE DRAWINGS

FIG. 1 illustrates a contents streaming system according to an embodiment of the present disclosure.

FIG. 2 illustrates a structure of a client device according to an embodiment of the present disclosure.

FIG. 3 illustrates a structure of a server according to an embodiment of the present disclosure.

FIG. 4 illustrates the concept of a contents streaming service according to an embodiment of the present disclosure.

FIG. 5 illustrates an example of a relative relationship between vectors.

FIG. 6 illustrates an example of the structure of a server according to an embodiment of the present disclosure.

FIGS. 7A and 7B illustrate examples of the structure of a model learning unit according to an embodiment of the present disclosure.

FIG. 8 illustrates an example of converting text metadata of content into sequence-type text data according to an embodiment of the present disclosure.

FIGS. 9A and 9B illustrate an example of learning a language model according to an embodiment of the present disclosure.

FIG. 9C illustrates an example of the structure of a prediction model according to an embodiment of the present disclosure.

FIG. 10A illustrates an example of learning a language model according to an embodiment of the present disclosure.

FIG. 10B illustrates an example of an input/output structure of a prediction model according to an embodiment of the present disclosure.

FIG. 10C illustrates the concept of a multi-class prediction model and a multi-label prediction model applicable to the present disclosure.

FIGS. 11A to 11E illustrate examples of a prediction value and similarity relationship of each content according to an embodiment of the present disclosure.

FIG. 12 illustrates an example of calculating similarity between contents using a learned language model according to an embodiment of the present disclosure.

FIG. 13 illustrates an example of a procedure for recommending content using a learned language model according to an embodiment of the present disclosure.

FIG. 14A illustrates an example of a procedure for performing learning on a language model according to an embodiment of the present disclosure.

FIG. 14B illustrates an example of learning on a language model using hashtag prediction according to an embodiment of the present disclosure.

FIG. 15A illustrates an example of a procedure for performing learning on a language model according to an embodiment of the present disclosure.

FIG. 15B illustrates an example of learning on a language model using genre prediction according to an embodiment of the present disclosure.

FIG. 16A illustrates an example of a procedure for performing learning on a language model according to an embodiment of the present disclosure.

FIG. 16B illustrates an example of a procedure for performing learning on a language model according to an embodiment of the present disclosure.

FIG. 16C illustrates an example of learning on a language model using a hashtag and a synopsis according to an embodiment of the present disclosure.

FIG. 17 illustrates an example of a procedure for determining similarity of content using a learned language model according to an embodiment of the present disclosure.

FIG. 18A illustrates an example of a structure of a transformer applicable to an embodiment of the present disclosure.

FIG. 18B illustrates an example of a detailed structure of encoder and decoder blocks of a transformer applicable to an embodiment of the present disclosure.

FIG. 19 illustrates an example of a structure of a BERT model applicable to an embodiment of the present disclosure.

FIG. 20 illustrates an example of a test set according to an embodiment of the present disclosure.

FIG. 21 illustrates an example of utilization of similar content determined according to an embodiment of the present disclosure.

### DETAILED DESCRIPTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

The present disclosure is to recommend content in a content streaming system, and specifically describes a technology for recommending content based on metadata in the form of text of the content. In particular, the present disclosure presents various embodiments for training a language model based on metadata in the form of text of the content and determining a similarity between contents using the trained language model.

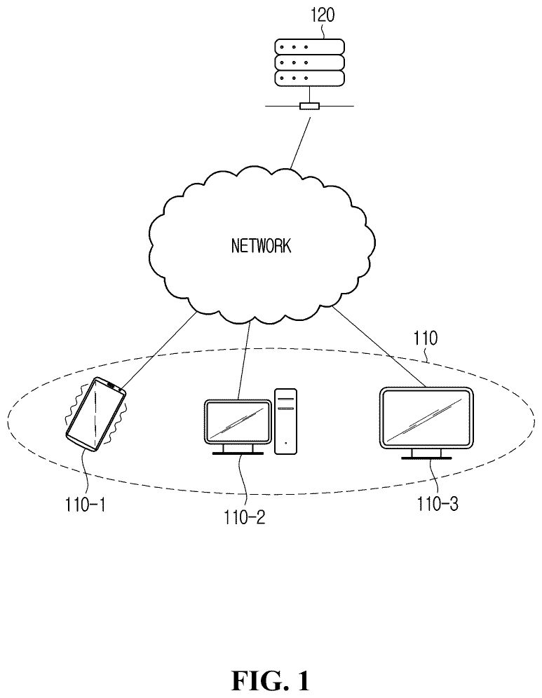

FIG. 1 illustrates a content streaming system according to an embodiment of the present disclosure. FIG. 1 illustrates a system for providing services related to content, such as content streaming and content-related information, and entities belonging to the system. Hereinafter, in the present disclosure, various services related to content may be referred to as a ‘content service’ or other terms having an equivalent technical meaning.

Referring to FIG. 1, the contents streaming system may include a client device 110 and a server 120. Here, the client device 110 is illustrated as a set of three client devices 110-1 to 110-3, but the contents streaming system may include two or less or four or more client devices. In addition, although one server 120 is illustrated, the contents streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 is a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may provide services related to content streaming and various contents to the client device 110 using various functions. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6th generation (6G), 5th generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

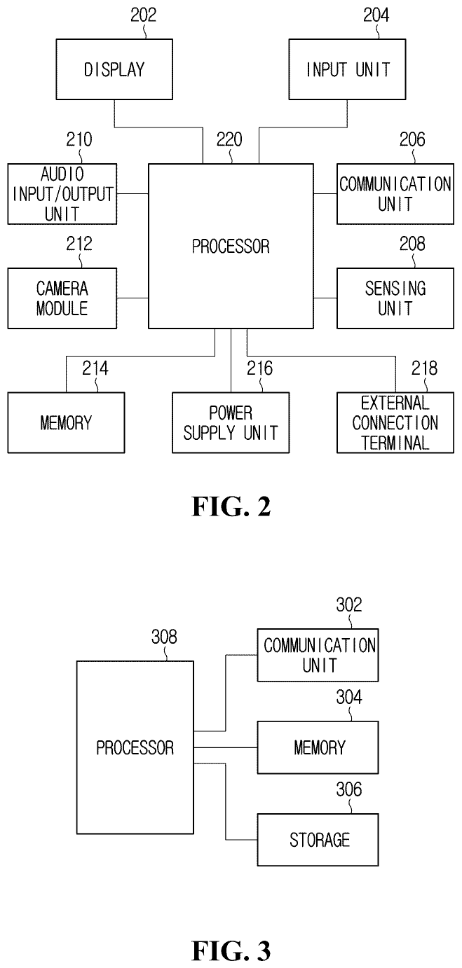

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing the measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may request content data from the server through the communication unit 206 and receive the content data. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being connected to the processor 220. Although not shown in FIG. 2, at least some of the components may be connected through a bus. In this case, under the control of the processor 220, direct data exchange may be made between some components.

FIG. 3 illustrates a structure of a server according to an embodiment of the present disclosure. FIG. 3 exemplifies a block structure of a server (the server 120 of FIG. 1).

Referring to FIG. 3, the server includes a communication unit 302, a memory 304, and a processor 308. However, according to various embodiments, at least one of the components illustrated in FIG. 3 may be omitted. In addition, according to various embodiments, at least one component may be included in addition to the components illustrated in FIG. 3.

The communication unit 302 provides an interface for communication between the server and another device. To this end, the communication unit 302 may include a circuit that generates and analyzes a physical signal for communication. The interface provided by the communication unit 302 may support wired communication or wireless communication.

The memory 304 may store various types of information, an order and/or information and load a computer program, an instruction, and the like stored in the storage 306. The memory 304 may temporarily store data and an instruction for an operation of the server and include a random access memory (RAM). Alternatively, the memory 304 may include various storage media.

The storage 306 may non-temporarily store an operation system for operating the server, a program for performing a function of the server, setting information for an operation of the server, and the like. For example, the storage 306 may include at least one of a non-volatile memory such as a read only memory (ROM), an erasable programmable ROM (EPROM), an electrically erasable programmable ROM (EEPROM), and a flash memory, a hard disk, a removable disc, a solid state drive (SSD), or any form of computer-readable recording medium widely known in the art to which the present disclosure belongs.

The processor 308 controls an overall operation of the server. The processor 308 may control operations of other components and perform various functions using other components. The processor 308 may include at least one of a central processing unit (CPU), a micro processor unit (MPU), a micro controller unit (MCU), or a well-known form of processor in the art to which the present disclosure belongs. Particularly, the processor 308 may control other components to enable the server to operate according to various embodiments described below and perform a necessary operation.

In a structure of the server described with reference to FIG. 3, components are exemplified to be all connected to the processor 308. Although not illustrated in FIG. 3, at least a part of the components may be connected through a bus. In this case, according to control of the processor 308, direct data exchange among some components may be made.

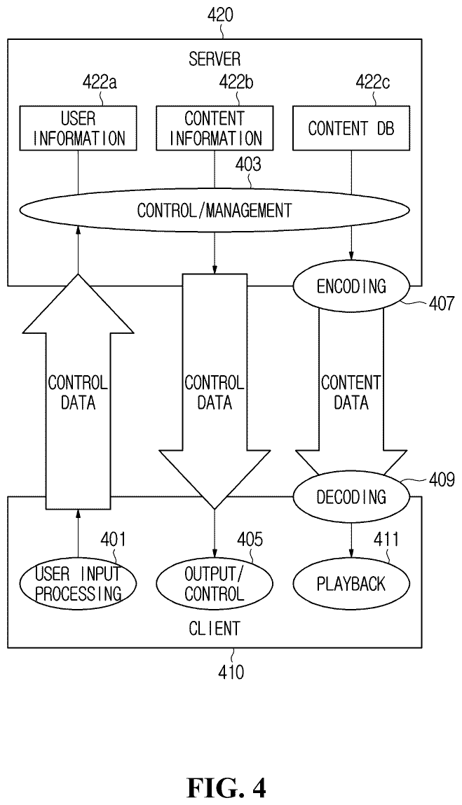

FIG. 4 illustrates a concept of a content streaming service according to an embodiment of the present disclosure. FIG. 4 is a schematic diagram of some functions related to content streaming, and a content streaming service according to various embodiments may have various other functions in addition to the functions illustrated in FIG. 4.

Referring to FIG. 4, control data and content data may be transmitted and received between the client 410 and the server 420. Specifically, transmission of control data from the client 410 to the server 420, transmission of control data from the server 420 to the client 410, and transmission of content data from the server 420 to the client 410 may be performed.

The server 420 stores user information 422a, content information 422b, and content database (DB) 422c. The user information 422a may include user account information, service use history information of users, information about user preferences, and the like. The content information 422b may include a list of serviceable content, content guide information, content meta information, and content consumption history information. The content DB 422c may include content stored in the form of data. In addition to this, the server 420 may further store other information required to provide services.

Control data transmitted from the client 410 to the server 420 may include information on user log-in, information on content selection by the user, information on control of content by the user, and the like. To this end, the client 410 may generate control data from user input through a user input processing operation 401 and transmit it. Control data from the client 410 is processed through a control/management operation 403 and used to provide content. For example, control data and/or content may be selected based on the control data from the client 401 by the control/management operation 403. In addition, preference may be determined by analyzing consumption history and behavior of the user by the control/management operation 403, and content to be recommended may be selected according to the determined preference.

A procedure for providing content to a user will be described with reference to FIG. 4 as follows. First, the client 410 generates control data including log-in information (e.g., ID and password) input by a user through the user input processing operation 401 and transmits the control data. The server 420 determines whether the user is valid by searching the user information 422a for log-in information included in the control data from the client 410, and determines the range of content and services allowed according to the user's authority. However, if log-in is not required or limited services that may be provided without log-in are supported, the transmission and processing of log-in information may be omitted.

Subsequently, the server 410 extracts content guide information from the content information 422b through the control/management operation 403 and transmits control data including the content guide information to the client 410. The client 410 outputs the content guide information included in the control data and confirms user's selection. The user's selection is transmitted to the server 410 as control data via the user input processing operation 401. Information about the user's selection is processed by the control/management operation 403 and used for selection of content to be streamed. The server 420 searches the content DB 422 for the selected content, compresses and segments the searched content through an encoding operation 407, and transmits content data. The content data may be compressed in advance through the encoding operation 407 and stored. Here, the encoding operation 407 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation is omitted, and the server 420 may perform segmentation on the content data. The content data may be restored through a decoding operation 409 and provided to a user through a playback operation 411. At this time, at least one of various video codecs or various audio codecs may be used for compression. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), Divx, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 310 may measure throughput (or bandwidth) and determine a bitrate based on the measured throughput (or bandwidth).

The client 410 may receive information about a plurality of content data from the server 420. The received information may include information representing the bitrate, resolution, number of frames per second, and location of a plurality of content data.

The client 410 may determine at least one of content data based on the bitrate, and determine reproduced content data corresponding to the resolution and number of frames per second that may be reproduced among the at least one content data based on the capability information of the client 410, and its location. In this case, the capability information may include the maximum support resolution and the maximum number of supported frames of the client, but is not limited thereto.

The client 410 may transmit a content request to the server 420 based on the location of reproduced content data. The server 420 may transmit content data corresponding to the content request to the client 410 based on the received content request.

According to another embodiment, the client 410 may receive user input related to at least one of the resolution or number of frames per second of the image, determine the reproduced content data and its location according to the user input, and transmit the content request to the server 420.

The present disclosure relates to a technology for recommending content based on metadata in the form of text (hereinafter referred to as “text metadata”) that describes the details of the content itself in a content streaming system. In particular, the present disclosure relates to a method and device for recommending content by training a language model based on text metadata of the content and determining a similarity between contents based on the trained language model. Here, the text metadata may include at least one of a title, a synopsis, a genre, a director, an actor, or a hashtag.

Content recommendation techniques may be broadly divided into two methodologies. One is a methodology using a collaborative filtering model, and the other is a methodology using a content-based filtering (CBF) model. The methodology using the collaborative filtering model recommends content based on interaction data between a user and content. On the other hand, the methodology using the CBF model recommends content similar to user's preferred content. The user's preferred content may include content that the user has watched, consumed, purchased, and/or selected. The methodology using the CBF model determines recommended content based on the characteristics of the content itself, so it has the advantage of being able to recommend content even without interaction data between the user and the content. In other words, using the CBF model can help solve the problem of cold start, where recommendations are difficult for new users or content without evaluation or purchase history. Accordingly, various content recommendation techniques based on the CBF model are currently being provided. For example, a technique that recommends content using a recurrent neural network-based model that uses movie and rating information metadata, a technique that recommends content based on a matrix obtained by taking the inner product of the user's movie rating and movie genre matrix, or a technique that recommends content using a nearest neighbor model based on metadata such as images, audio, tags, and genres of the content may be used. However, most of these existing CBF model-based techniques only utilize metadata indicating the characteristics of the content, and do not utilize text metadata that describes the details of the content itself.

Therefore, hereinafter, the present disclosure will describe various embodiments of recommending content by utilizing text metadata describing the details of the content itself, based on the methodology utilizing the CBF model. For example, the text metadata describing the details of the content itself may include at least one of a title, a synopsis, a composite genre, a director, an actor, or a hashtag. In addition, in the embodiments of the present disclosure, a language model may be used for recommending content, and the language model may be learned based on text metadata. The language model may be a transformer-based model as a natural language processing model for digitizing, i.e., embedding, the text metadata of the content so that a computer can understand it. For example, the transformer-based model may include, but is not limited to, BERT, ELECTRA, RoBERTa, BART, GPT3, DeBERTa, and KLUE-RoBERTa-large models.

Before explaining a specific method for recommending content using a language model, the present disclosure explains the basic concepts of natural language processing and the RoBERTa model to help understand the CBF model.

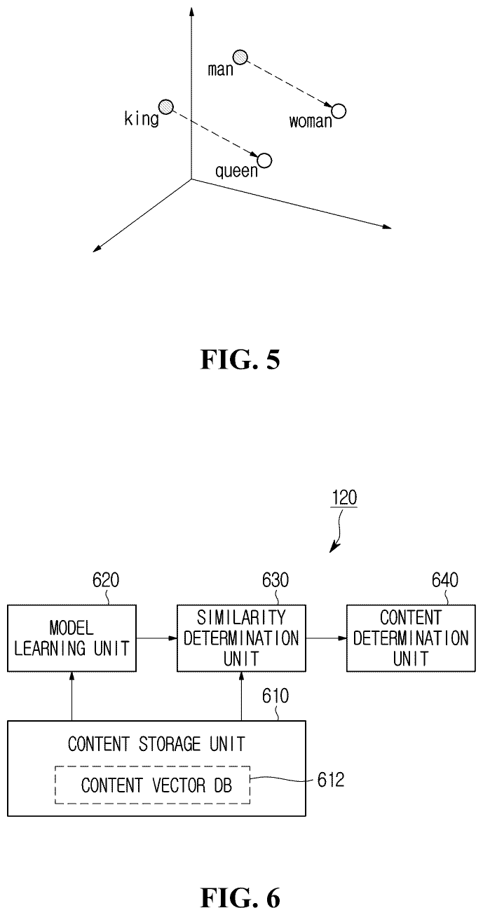

In order to determine the similarity between contents based on the CBF model, it is necessary to digitize metadata composed of natural language, i.e., unstructured data, into data that a computer can understand. At this time, the technology of digitizing, i.e., vectorizing, natural language, unstructured data into data that a computer can understand is called embedding. Natural language, unstructured data may be expressed as vectors through embedding, and the vectors may be mapped to a vector space, as illustrated in FIG. 5. At this time, the distance and/or direction between vectors may be interpreted as information on a relative relationship between vectors. FIG. 5 illustrates an example of a relative relationship between vectors. For example, if a vector 501 representing a king is referred to as v1, a vector 502 representing a queen is referred to as v2, a vector 503 representing a man is referred to as v3, and a vector 504 representing a woman is referred to as v4 in FIG. 5, then since king and queen, and man and woman have similar meanings related to gender, the distances (v1, v2) and (v3, v4) may be similar, and the directions (v1, v2) and (v3, v4) may be similar. On the other hand, although not shown in FIG. 5, if a vector representing a computer is referred to as v5, the distance (v1, v5) will be further than the distance (v1, v2), and the directions (v1, v5) and (v1, v2) will be different. In this manner, the relative similarity between vectors may be determined. In the example of FIG. 5, the embedding size, which is the length of the vector, is set to three dimensions, but the embedding size in an actual CBF model may be set to a higher multidimensionality. This is because when a vector has a multidimensional embedding size, it may contain more complex meanings.

In a CBF model that represents content as a vector, it is important to ensure that the vector accurately represents the semantic information of the content. This is because the similarity between the contents may be accurately determined only when the vector accurately represents the semantic information of the content. Therefore, according to embodiments of the present disclosure, in order to express the content as a vector having accurate semantic information, the system will fine-tune the language model of the CBF model by training the language model. Specifically, in various embodiments of the present disclosure, the language model may be trained to convert an input text sequence including meta information such as a title, synopsis, etc. of each content into a vector having accurate semantic information.

The language model is a model that has the ability to vectorize input text, and may be divided into a word-level embedding model and a sentence or document-level embedding model. The word-level embedding model is a model that assigns the same vector to words with the same form, for example, a word2vec model. The sentence-level embedding model is a model that distinguishes each word by considering context information, for example, a BERT model.

To examine the difference between the word-level embedding model and the sentence-level embedding model, assume an input text sequence, “The snow falling on a winter night is beautiful.” In the case of the word-level embedding model, the “snow” in the input text sequence and the “eye” which is a human body part are expressed by the same vector. On the other hand, in the case of the sentence-level embedding model, by utilizing the context information of the entire input text sequence, the “snow” in the input text sequence and the “eye” which is a human body part may be expressed by different vectors. In this way, the sentence-level embedding model may express the input text sequence as a vector containing more correct semantic information than the word-level embedding model. Therefore, according to one embodiment, RoBERTa, which is one of the sentence-level embedding models, may be used.

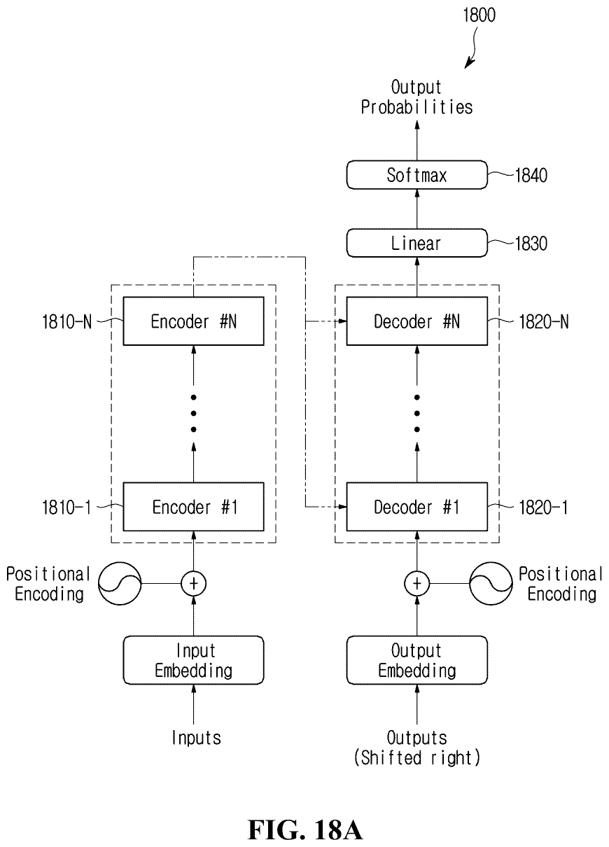

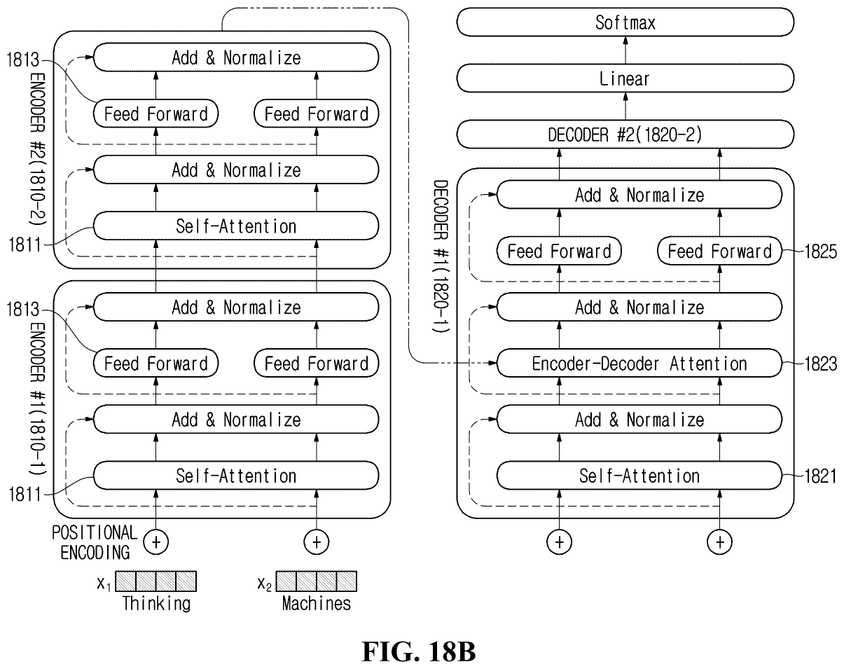

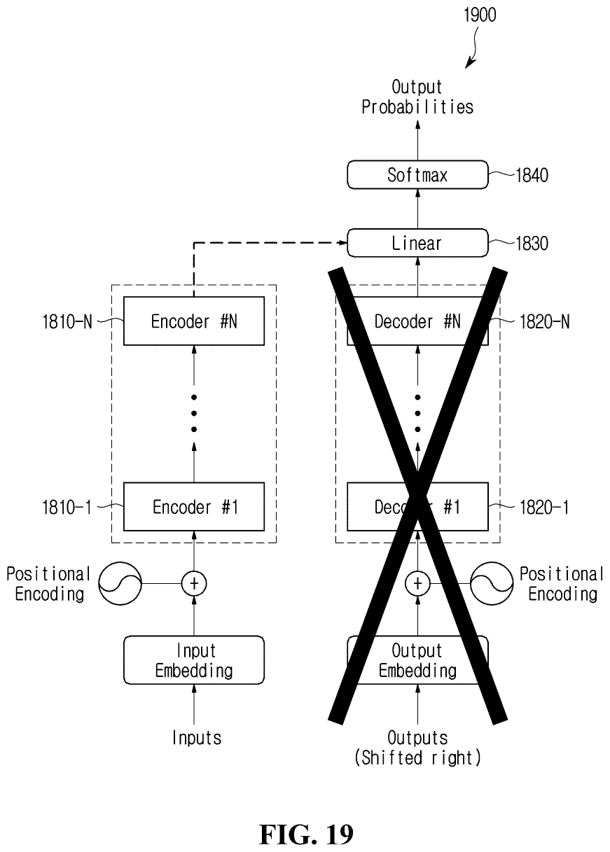

The RoBERTa model is a model developed from the BERT model. The BERT model is the predecessor of the RoBERTa model and is a language model that has pre-learned a large amount of text data through unsupervised learning. The BERT model has a structure in which encoder blocks of the transformer structure are stacked in multiple layers, and is pre-learned using a masked language model (MLM) method and a next sentence prediction (NSP) method. The structure of the transformer and the structure of the BERT model will be described in detail later with reference to FIGS. 18A, 18B, and 19.

The MLM method is a method that predicts randomly masked words, and the NSP method is a method that predicts whether two sentences may appear consecutively in context. The BERT model has a structure that learns text in both directions, so it has the advantage of obtaining better semantic representation information compared to models with a unidirectional structure.

RoBERTa is a model trained after adding learning data and adjusting hyper parameters and training techniques to enhance the performance of the BERT model. The RoBERTa model may be trained only with the MLM method, excluding the NSP method. The RoBERTa model has been improved to undergo longer training with larger learning data and longer sequences than the BERT model, and to obtain more sophisticated semantic representation information by applying dynamic masking. In other words, RoBERTa has been improved to have better performance than the GLUE (general language understanding evaluation) benchmark performance of previous models including BERT.

Therefore, the system according to the embodiments of the present disclosure may use the RoBERTa model, which is a natural language processing model pre-trained on the Korean corpus, for content recommendation. However, the language model in the embodiments described below is not necessarily limited to the RoBERTa model, and may be applied even when a language model other than RoBERTa is used.

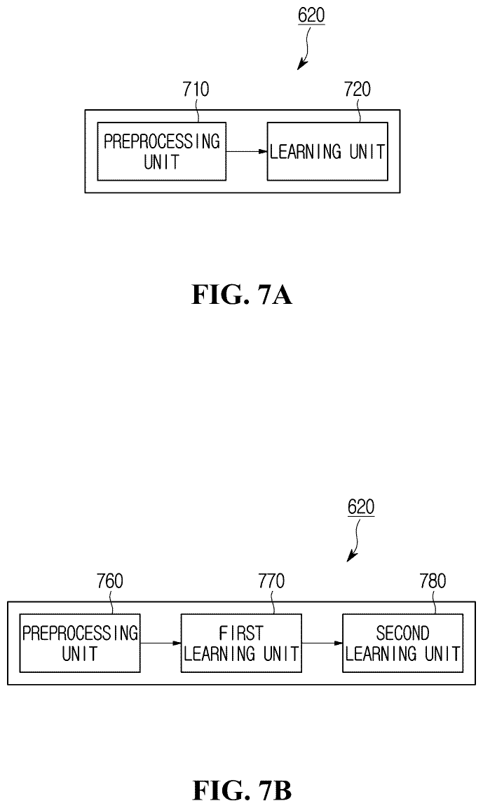

FIG. 6 illustrates an example of a structure of a server that recommends content according to an embodiment of the present disclosure. At least some components of the server (e.g., the server 120 of FIG. 1) illustrated in FIG. 6 may be understood as components included in the processor 308 of FIG. 3. Hereinafter, a description of at least some components of FIG. 6 will be provided with reference to FIGS. 7A to 13.

Referring to FIG. 6, the server 120 may include a content storage unit 610, a model learning unit 620, a similarity determination unit 630, and a content determination unit 640.

The content storage unit 610 stores content items that may be provided to clients. The content items include movie content, drama content, and program content that may be streamed, and one content item corresponds to one movie, one drama, or one program. For example, a first content item and a second content item may correspond to different movies. However, according to another embodiment, the content storage unit 610 may exist outside the server 120, and in this case, the server 120 may access the external content storage unit 610 and search for and obtain content items.

According to one embodiment, the content storage unit 610 may include a content vector DB 612. The content vector DB 612 stores the vector value of each of the content items stored in the content storage unit 610. The vector value of each of the content items may be obtained using a language model learned by the model learning unit 620. The content vector DB 612 may be updated by the updated language model when the language model is updated. For example, the language model may be updated by being relearned when a new content item is stored in the content storage unit 610 or when a previously stored content item is deleted. That is, the content vector DB 612 may obtain and store the vector value of each of the content items using the updated language model when the language model is relearned and updated. At this time, the vector value of each of the previously stored content items may be deleted.

According to one embodiment, the content vector DB 612 may be updated automatically periodically or when a specified event occurs, or may be updated under the control of a business operator and/or an administrator. For example, when a new content item is stored in the content storage unit 610, the content vector DB 612 may be updated to additionally store the vector value of the new content item. As another example, when a content item previously stored in the content storage unit 610 is deleted, the content vector DB 612 may be updated to delete the vector value of the deleted content item.

The model learning unit 620 may perform learning on the language model based on text metadata describing the details of the content item. The text metadata refers to a text feature describing the details of the content item. The text metadata may include at least one of the title, synopsis, composite genre, director, actor, and hashtag information of the content item. Here, the composite genre may include at least one of a major category genre or a minor category genre. For example, the minor category genre of the major category genre ‘action/SF’ may be classified into ‘action’, ‘fantasy’, ‘SF’, ‘adventure’, ‘war’, ‘martial arts’, etc. The hashtag information refers to tag information indicating at least one of the topic, emotion, or purpose of the content item. The synopsis refers to overview information indicating at least one of the topic, planning intention, or plot of the content item.

According to one embodiment, the model learning unit 620 may include a preprocessing unit 710 and a learning unit 720, as illustrated in FIG. 7A, or may include a preprocessing unit 750, a first learning unit 760, and a second learning unit 770, as illustrated in FIG. 7B. FIGS. 7A and 7B illustrate examples of the structure of a model learning unit according to an embodiment of the present disclosure.

First, referring to FIG. 7A, the preprocessing unit 710 of the model learning unit 620 obtains text metadata of a content item for learning a language model, and converts the obtained text metadata into sequence-type text data. The sequence-type text data refers to data in the form of a string in which text data are continuously connected. The reason why the preprocessing unit 710 converts the text metadata into the sequence-type text data is because text data classified as unstructured data, such as metadata of a content item, cannot be directly input into a language model. Therefore, the preprocessing unit 710 may convert the text metadata into sequence-type text data by dividing the text metadata of a content item into token units and then inserting at least one separator. Here, a token refers to an input unit of a language model that is replaced with a unique embedding value, and at least one separator that is inserted may also be treated as a token. At least one separator may include at least one of a separator token (e.g., [September]) for separating different types of features, and special tokens representing specific features. The special tokens may include at least one of special tokens [GENRE] and [/GENRE] representing a genre, special tokens [DIR] and [/DIR] representing a director, special tokens [ATR] and [/ATR] representing an actor, and special tokens [TAG] and [/TAG] representing a hashtag. The listed special tokens are only examples to help understanding, and the embodiments of the present disclosure are not limited thereto. Each special token may be inserted before or after the text corresponding to the feature. The reason why the special token is used in the present disclosure is because various types of features are included in the text metadata of the content item. That is, it may be difficult for the language model to recognize various types of features only with the separator tokens and/or the order of the separator tokens included in the input sequence. The special token may be added to the vocabulary of the language model.

According to one embodiment, the preprocessing unit 710 may convert text metadata including an identification code, title, genre, director, actor, hashtag, and synopsis of a content item into sequence-type text data including separators as shown in [Table 1] below.

TABLE 1
Title [SEP] Synopsis Token 1 Synopsis Token 2 ... Synopsis Token N
[GENRE] Genre 1 Genre 2 [/GENRE] [DIR] Director [/DIR] [ATR]
Actor 1 Actor 2 [/ATR] [TAG] Tag 1 Tag 2 [/TAG]

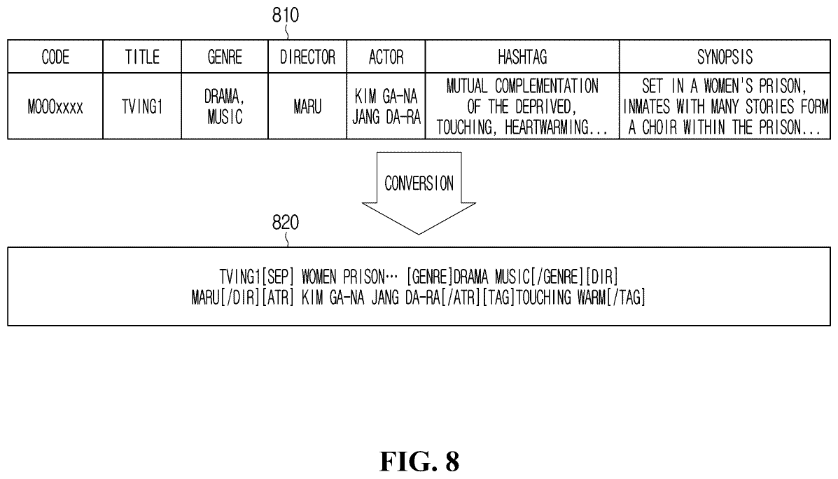

In [Table 1], Synopsis Token 1, Synopsis Token 2, and Synopsis Token N each represent different tokens included in the synopsis of the corresponding content item. As a specific example, the preprocessing unit 710 may generate sequence-type text data as illustrated in FIG. 8. FIG. 8 illustrates an example of converting text metadata of content into sequence-type text data according to an embodiment of the present disclosure. Referring to FIG. 8, the preprocessing unit 710 may convert text metadata 810 of the content item into sequence-type text data 820 by adding separation tokens and special tokens. At this time, if there are multiple directors and/or actors of the corresponding content item, the preprocessing unit 710 may limit the number of directors and/or actors included in the sequence-type text data. For example, the number of directors and/or actors may be limited to a maximum of 5, but is not limited thereto. The preprocessing unit 710 provides the generated sequence-type text data to the first learning unit 720.

The learning unit 720 of the model learning unit 620 performs learning on a language model based on sequence-type text data. That is, the learning unit 720 may perform learning on a language model by performing training on a prediction model based on a specific type of information among the sequence-type text data obtained by the preprocessing unit 710. The specific type of information may include hashtag information, genre information, or synopsis information. Specifically, the learning unit 720 may perform any one of the first to third embodiments below.

### First Embodiment

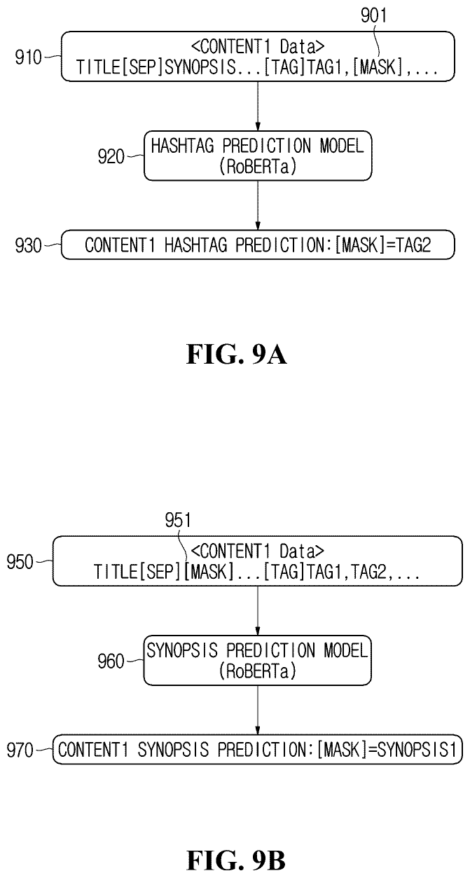

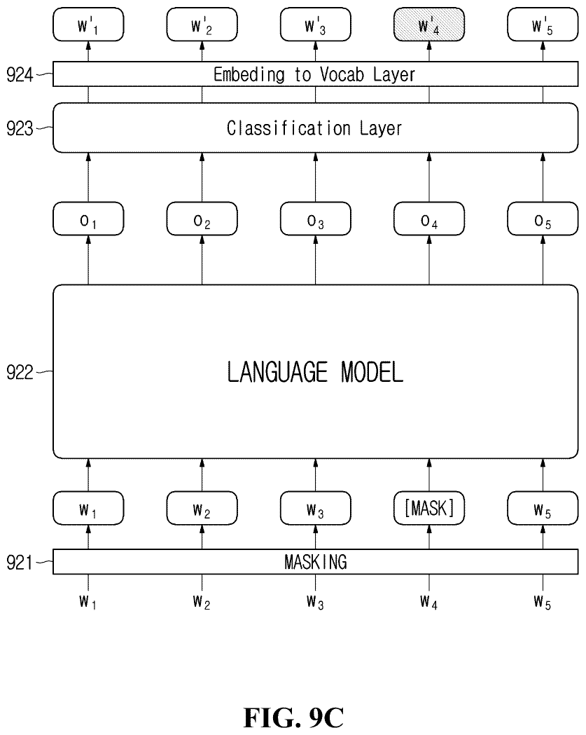

According to the first embodiment, the learning unit 720 may perform learning on a language model by training a prediction model based on hashtag information in sequence-type text data. Here, the prediction model may include a hashtag prediction model, which is a prediction model of an MLM method configured to predict or infer masked hashtag tokens based on a language model. For example, the learning unit 720 may perform learning on a language model as illustrated in FIG. 9A. FIG. 9A illustrates an example of learning a language model according to an embodiment of the present disclosure.

Referring to FIG. 9A, the learning unit 720 may mask one token (e.g., ‘Tag 2’) corresponding to a hashtag among tokens included in the sequence-type text data, and define the value of the masked token as a label. The learning unit 720 may input text data 910 including the masked token 901 to the hashtag prediction model 920, determine a loss value using the output value and the label, and perform backpropagation based on the loss value, thereby performing training and/or learning for the hashtag prediction model 920. Accordingly, the hashtag prediction model 920 may be trained and/or learned to predict 930 and/or infer the value of the masked token 901. At this time, the hashtag prediction model 920 may be trained or learned to obtain context information from other unmasked tokens and infer a masked token, i.e., a token corresponding to a hashtag, based on the obtained context information. For example, the hashtag prediction model 920 may be learned based on context information obtained from unmasked tokens, such as a title, a synopsis, etc. In this way, the input and target for the learning task of the hashtag prediction model 920 based on a language model may be expressed as shown in [Table 2] below.

TABLE 2

| Prediction | Input | Target |
|---|---|---|
| Hashtag | Title [SEP] Synopsis Token 1 Synopsis Token 2 . . . Synopsis Token N [GENRE] | [MASK] = |
| prediction | Genre 1 Genre 2 [/GENRE] [DIR] Director [/DIR] [ATR] Actor 1 Actor 2 [/ATR] | Tag 2 |
| | [TAG] Tag 1 [MASK] [/TAG] | |

[Table 2] shows that when the token of ‘Tag 2’ among the plurality of tokens located in a hashtag area is masked and input to the hashtag prediction model 920, the hashtag prediction model 920 is learned to infer the token of ‘Tag 2’. Here, the reason why only one token is masked even though there are a plurality of tokens in the hashtag area is because, when two or more tokens are masked, it is not easy for the language model to identify the positional relationship between the masking tokens included in the input and the target tokens. Therefore, the learning unit 720 according to the first embodiment may operate in a manner of masking and inferring one token in the hashtag area, and then masking and inferring another token in the hashtag area. For example, the token masked in the hashtag area may vary from epoch to epoch. According to the first embodiment, the learning unit 720 may mask tokens that do not start with ‘#’, i.e., non-dependent tokens, among tokens located in the hashtag area. The hashtag area may be determined based on special tokens [TAG] and [/TAG] representing hashtags.

### Second Embodiment

According to the second embodiment, the learning unit 720 may perform learning on the language model by training the prediction model based on the synopsis information in the sequence-type text data. Here, the prediction model may include a synopsis prediction model, which is a prediction model of the MLM method configured to predict or infer masked synopsis tokens based on the language model. For example, the learning unit 720 may perform learning on the language model as illustrated in FIG. 9B. FIG. 9B illustrates an example of learning a language model according to an embodiment of the present disclosure.

Referring to FIG. 9B, the learning unit 720 may mask one token (e.g., ‘Synopsis Token 1’) corresponding to the synopsis among the tokens included in the sequence-type text data, and define the value of the masked token as a label. The learning unit 720 may input text data 950 including a masked token 951 to a synopsis prediction model 960, determine a loss value using the output value and the label, and perform backpropagation based on the loss value, thereby performing training and/or learning for the synopsis prediction model 960. Accordingly, the synopsis prediction model 960 may be trained and/or learned to predict 970 and/or infer the value of the masked token 951. At this time, the synopsis prediction model 960 may be trained or learned to obtain context information from other unmasked tokens and infer a masked token, i.e., a token corresponding to a synopsis, based on the obtained context information. For example, the synopsis prediction model 960 may be learned based on context information obtained from unmasked tokens, such as a title, a genre, a hashtag, etc. In this way, the input and target for the learning task of the synopsis prediction model based on a language model may be expressed as shown in [Table 3] below.

TABLE 3

| Prediction | Input | Target |
|---|---|---|
| Synopsis | Title [SEP] [MASK] Synopsis Token2 . . . Synopsis TokenN [GENRE] Genre1 | [MASK] = |
| prediction | Genre2 [/GENRE] [DIR] Director [/DIR] [ATR] Actor1 Actor2 [/ATR] [TAG] Tag1 | Synopsis |
| | Tag2 [/TAG] | Token 1 |

[Table 3] shows that when the token of ‘Synopsis Token l’ among the plurality of tokens located in the synopsis area is masked and input to the synopsis prediction model 960, the synopsis prediction model 960 is learned to infer the token of ‘Synopsis Token 1’. Here, the reason why only one token is masked even though there are the plurality of tokens in the synopsis area is because it is not easy for the language model to identify the positional relationship between the masking tokens included in the input and the target tokens when two or more tokens are masked. Therefore, the learning unit 720 according to the second embodiment may operate in a manner of masking and inferring one token in the synopsis area, and then masking and inferring another token in the synopsis area. For example, the token masked in the synopsis area may vary from epoch to epoch. The learning unit 720 according to the second embodiment is not limited to masking and inferring tokens of the synopsis area, and may also mask and infer tokens of the title area. For example, the learning unit 730 may mask and infer tokens of the title area in addition to the synopsis area. Alternatively, the learning unit 730 may mask and infer tokens of the title area instead of the synopsis area.

According to the second embodiment, the learning unit 720 may mask tokens that do not start with ‘#’, i.e., non-dependent tokens, among tokens located in the synopsis area. The synopsis area may be determined based on a separator token and/or a special token. For example, the synopsis area may be determined as an area between a separator token [September] and a special token [GENRE] for a genre. However, this is only an example for a case where text metadata of a content item is converted into sequence-type text data as in [Table 1], and the method of determining the synopsis area is not limited thereto. For example, if the sequence-type text data is composed of “Title[September]Director[SYNOPSIS]Synopsis Token1 Synopsis Token2 . . . Synopsis TokenN[/SYNOPSIS][GENRE]Genre1 Genre2[/GENRE][ATR]Actor1 Actor2[/ATR][TAG]Tag1 Tag2[/TAG]”, the synopsis area may be determined to be an area between [SYNOPSIS] and [/SYNOPSIS], which are special tokens representing the synopsis. In other words, the synopsis area may vary depending on the method of configuring the sequence-type text data.

In the first and second embodiments described above, the reason why tokens that do not start with ‘#’ are masked is because, due to the characteristics of the BPE (Byte Pair

Encoding) tokenizer of the RoBERTa model, tokens that start with “#” are dependent on the preceding token or are tokens with grammatical meaning. In other words, tokens that relatively include core meanings such as nouns and verbs do not start with ‘#’, so the learning unit 720 may mask tokens that do not start with ‘#’ among the tokens located in the synopsis area. For example, when the BPE tokenizer divides a text sentence into token units, it may divide “Mr. XX is working at an interesting OTT field, Tving” into “#Mr.+XX+#is+work+#-ing+#at+#an+interest+#-ing+OTT+field+#, +Tving”. As in the example above, the tokenizer may indicate that a token is dependent on a preceding token by adding ‘#’ to the dependent token.

The way to indicate a dependent token is not limited to the way of adding ‘#’ to the token. For example, in the case of other tokenizers, ‘##’ or ‘_’ may be added to the dependent token, and various other ways may be used to indicate that the token is a dependent token. Therefore, the form of the dependent token is not limited to a specific form, and the learning unit 720 may mask tokens that are not dependent tokens.

According to one embodiment, the hashtag prediction model 920 and/or the synopsis prediction model 960 may include, as illustrated in FIG. 9C, a masking block 921 that masks at least one token among a plurality of input tokens (e.g., [W₁, W₂, W₃, W₄, W₅]), a language model 922 that outputs vector values (e.g., [O₁, O₂, O₃, O₄, O₅]) corresponding to the plurality of input tokens (e.g., [W₁, W₂, W₃, [MASK], W₅]) including masked tokens, a classification layer 923 that infers vector values of the masked tokens from vector values output from the language model, and an embedding to vocabulary layer 924 that converts the vector values into tokens. Here, the language model 922 may include a RoBERTa model. In addition, the classification layer 923 may include a fully connected layer, a Gaussian error linear unit (GELU), and a norm, and may be referred to as an MLM head layer. The classification layer 923 may output prediction tokens (e.g., [W′₁, W′₂, W′₃, W′₄, W′₅]) corresponding to the plurality of input vector values (e.g., [O₁, O₂, O₃, O₄, O₅]). The prediction model 920 may be trained to predict and/or infer a masked token (e.g., W₄) that is appropriate for the content and does not overlap with the unmasked tokens, based on context information from the unmasked tokens (e.g., [W₁, W₂, W₃, W₅]), i.e., the target.

### Third Embodiment

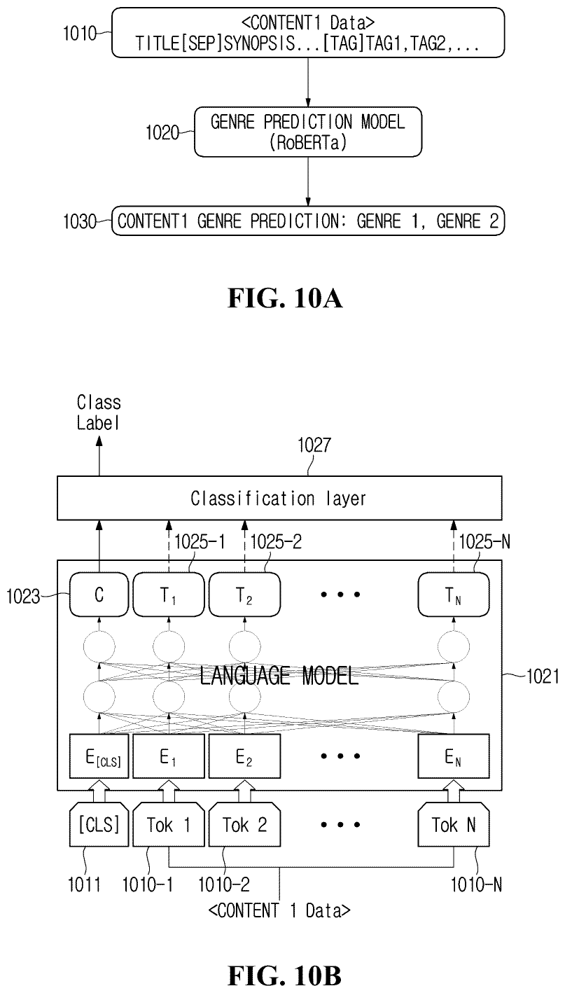

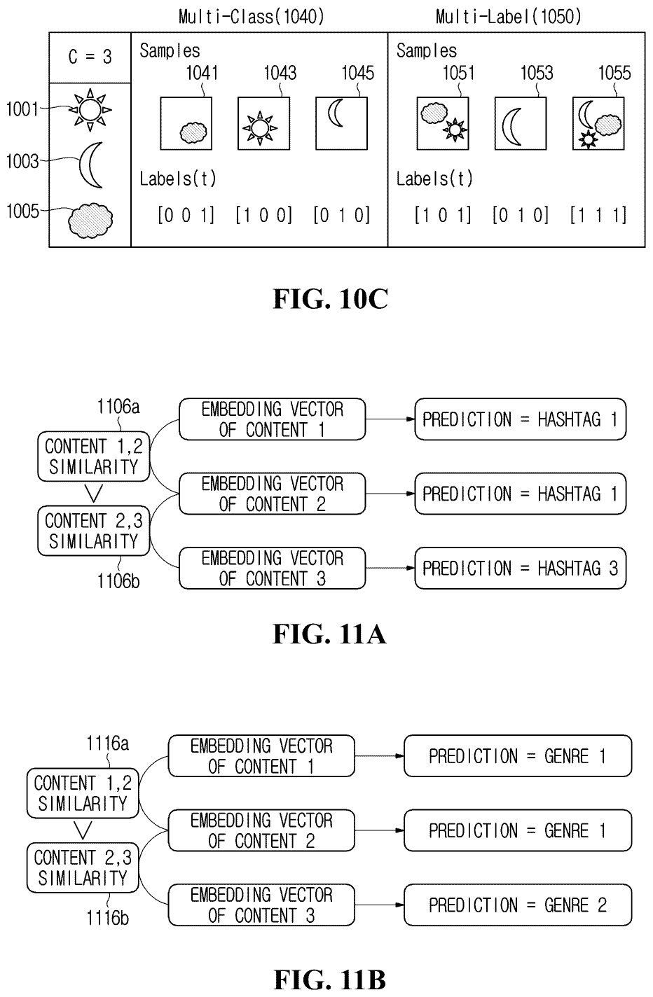

According to the third embodiment, the learning unit 720 may perform learning on a language model by training a prediction model based on genre information in sequence-type text data. At this time, the prediction model may include a genre prediction model, which is a prediction model of a text classification method configured to predict or infer genres for content items based on a language model. For example, the learning unit 720 may perform learning on a language model as illustrated in FIG. 10A. FIG. 10A illustrates an example of learning a language model according to an embodiment of the present disclosure.

Referring to FIG. 10A, the learning unit 720 obtains input sequence-type text data that does not include genre-related tokens, and performs a text classification task using a genre prediction model 1020, thereby predicting a genre to which a content item having the input sequence-type text data belongs. The text classification task refers to a task of distinguishing which class a text input to a prediction model belongs to. Here, the input sequence-type text data may be generated by removing genre-related tokens from the sequence-type text data. The genre-related tokens may include special tokens [GENRE] and [/GENRE] representing a genre, and tokens corresponding to genre information (hereinafter, “genre tokens”). The genre tokens are located in a genre area between special tokens [GENRE] and [/GENRE] representing a genre, and may include at least one token representing a genre. For example, a genre token expressing a genre called ‘horror/thriller’ may include three tokens called ‘horror’, ‘/’, and ‘thriller’, and a genre token expressing a genre called ‘drama’ may include one token called ‘drama’. The input sequence-type text data may be generated in the preprocessing unit 710 or the learning unit 720.

Specifically, the learning unit 720 may obtain at least one token representing at least one genre from the sequence-type text data, and set a class label based on the obtained at least one token. Here, one genre may be expressed by one or more tokens. For example, the genre “horror/thriller” may be expressed by three tokens “horror”, “/”, and “thriller”, and the genre “drama” may be expressed by one token “drama”. Therefore, when one or more tokens representing one genre are obtained from the sequence-type text data, the learning unit 720 may set a class label to predict one genre based on the obtained one or more tokens. In addition, when a plurality of tokens representing a plurality of genres are obtained from the sequence-type text data, the learning unit 720 may set a class label to predict a plurality of genres based on the obtained plurality of tokens. The learning unit 720 may use a multi-class classification model or a multi-label classification model depending on the number of genres to be predicted, which will be described later in FIG. 10C.

The learning unit 720 inputs input sequence-type text data 1010 that does not include a genre-related token to a genre prediction model 1020, determines a loss value (e.g., cross entropy) using the output value of the genre prediction model 1020 and a preset class label, and performs backpropagation based on the loss value, thereby performing training and/or learning on the genre prediction model 1020. Accordingly, the genre prediction model 1020 may be trained and/or learned to predict 1030 and/or infer at least one genre set as a class label from the input sequence-type text data 1010.

According to the third embodiment, the genre prediction model 1020 may include, as illustrated in FIG. 10B, a language model 1021 that outputs vector values (e.g., [C, T₁, T₂, . . . , T_{N}]) corresponding to input tokens (e.g., [CLS, Tok1, Tok2, . . . , TokN]), and a classification layer 1027 that outputs a probability value of a class label based on at least one vector value output from the language model 1021. Here, the language model 1021 may include a RoBERTa model. In addition, the classification layer 1027 may be referred to as a text classification layer, and/or a text classification head layer.

As illustrated in FIG. 10B, the learning unit 720 may obtain a genre prediction result for the corresponding content from the prediction model 1020 by inputting input sequence-type text data 1010 that does not include a genre-related token to the prediction model 1020. At this time, the input sequence-type text data 1010 may include a plurality of tokens Tok1, Tok2, . . . , TokN 1010-1, 1010-2, . . . , 1010-N. The learning unit 720 may add a start token, [CLS] 1011, to the start position of the input sequence-type text data 1010 and input it to the language model 1021. The language model 1021 may output the last hidden vector C 1023 corresponding to the start token [CLS] 1011, and the last hidden vectors T₁, T₂, . . . , T_{N} 1025-1, 1025-2, . . . , 1025-N corresponding to the plurality of tokens Tok1, Tok2, . . . , TokN 1010-1, 1010-2, . . . , 1010-N. The last hidden vector C 1023 may be an output vector that reflects context information of the entire plurality of tokens Tok1, Tok2, . . . , TokN 1010-1, 1010-2, . . . , 1010-N included in the input sequence-type text data 1010. The last hidden vector C 1023 is input to the classification layer 1027, and the classification layer 1027 may output the probability value of the class label based on the last hidden vector C 1023. The learning unit 1020 may predict the class to which the corresponding content belongs, i.e., the genre, based on the output probability value of the class label. According to one embodiment, the classification layer 1027 may use only the last hidden vector C 1023 as input, or may use the last hidden vector C 2023 and other last hidden vectors T₁, T₂, . . . , T_{N} 1025-1, 1025-2, . . . , 1025-N as input together. For example, the classification layer 1027 may receive the average pooling of the last hidden vectors T₁, T₂, . . . , T_{N} 1025-1, 1025-2, . . . , 1025-N output from the language model 1021 and output the probability value of the class label based on this.

As described above, the genre prediction model 1020 may be trained or learned to obtain context information from all tokens included in the input sequence-type text data 1010 and infer the genre based on the obtained context information. For example, the genre prediction model 1020 may be learned based on context information obtained from tokens such as a title, synopsis, hashtags, etc. In this way, the input and target for the learning task of the genre prediction model based on the language model may be represented as shown in [Table 4] below.

TABLE 4

| Prediction | Input | Target |
|---|---|---|
| Genre | Title [SEP] Synopsis Token 1 Synopsis Token 2 . . . Synopsis Token N [DIR] | Genre 1, Genre 2 |
| prediction | Director [/DIR] [ATR] Actor 1 Actor 2 [/ATR] [TAG] Tag 1 Tag 2 [/TAG] | |

[Table 4] shows that when input sequence-type text data is input to the prediction model, the genre prediction model is trained to infer tokens of ‘genre 1’ and ‘genre 2’. Here, the target means a class label, and there being multiple targets of ‘genre 1’ and ‘genre 2’ means that the corresponding content item may belong to multiple genres rather than one genre. For example, a specific content item may belong to the ‘action/SF’ genre among the major category genres and the ‘fantasy’ genre among the minor genres. In general, the genres of content items may be classified into major category genres and/or minor genres. The major category genres may include drama, romance/melodrama, comedy, action/SF, horror/thriller, etc. The minor genres may include drama, action, thriller, romance, comedy, horror, fantasy, SF, crime, historical drama, war, martial arts, etc. The listed genres are only examples to help understanding, and the embodiments of the present disclosure are not limited thereto. As described above, genres of content items may be categorized in various ways, and one content item may belong to one or more genres. Accordingly, the genre prediction model according to the third embodiment may be learned to infer only one genre to which a content item belongs, or may be trained to infer one or more genres to which a content item belongs. For example, the prediction model 1020 may be trained to infer one or more genres to which a content item belongs, by including a multi-class classification model or a multi-label classification model based on a supervised learning algorithm, as illustrated in FIG. 10C.

FIG. 10C illustrates the concept of a multi-class classification model and a multi-label classification model applicable to the present disclosure. In FIG. 10C, C may mean the number of classes. That is, FIG. 10C assumes a case where there are three classes 1001, 1003 and 1005.

The multi-class classification model 1040 is a model for inferring one class to which an input sample belongs among multi-classes. Therefore, the label of the multi-class classification model 1040, i.e., the target vector t, may be set to a one-hot vector having one positive class and C−1 negative classes. For example, the label for a first input sample 1041 of the multi-class classification model 1040 may be set to [001], the label for a second input sample 1043 may be set to [100], and the label for a third input sample 1043 may be set to [010]. Here, the label is an expected output vector value for the input sample and may be set based on the class to which the input sample actually belongs. For example, a label set to [100] may mean that the corresponding input sample actually belongs to the first class 1001, but does not belong to the second class 1003 or the third class 1005, and a label set to [010] may mean that the corresponding input sample actually belongs to the second class 1003, but does not belong to the first class 1001 or the third class 1005. Additionally, a label set to [001] may mean that the corresponding input sample actually belongs to the third class 1005, but does not belong to the first class 1001 or the second class 1003.

The multi-label classification model 1050 is a model for inferring multiple classes to which an input sample belongs among multi-classes. The label of the multi-label classification model, i.e., the target vector t, may be set to a vector having multiple positive classes. For example, the label for a fourth input sample 1051 of the multi-label classification model may be set to [101], the label for a fifth input sample 1053 may be set to [010], and the label for a sixth input sample 1055 may be set to [111]. Here, the label is an expected output vector value for the input sample and may be set based on one or more classes to which the input sample actually belongs. For example, a label set to [101] may mean that the corresponding input sample actually belongs to the first class 1001 and the third class 1005, a label set to [010] may mean that the corresponding input sample actually belongs to the second class 1003, and a label set to [111] may mean that the corresponding input sample actually belongs to the first class 1001, the second class 1003, and the third class 1005.

The learning unit 720 may be learned to infer one or more genres to which each content item belongs through the genre prediction model 1020 configured based on the multi-class classification model 1040 or the multi-label classification model 1050 as illustrated in FIG. 10C. In the structure described above, the more accurately the genre prediction model infers the target, the more sophisticated the semantic representation of the language model may become.

Next, referring to FIG. 7B, the preprocessing unit 760 of the model learning unit 620 obtains text metadata of a content item for learning a language model, and converts the obtained text metadata into sequence-type text data. That is, the preprocessing unit 760 may convert text metadata including an identification code, title, genre, director, actor, hashtag, and synopsis of a content item into sequence-type text data including separators as in [Table 1]. In other words, the preprocessing unit 760 of FIG. 7B may perform at least one operation that may be performed in the preprocessing unit 710 of FIG. 7A.

The first learning unit 770 performs primary learning on the language model using a prediction model configured to predict or infer masked tokens. The first learning unit 770 may perform primary learning on the language model by training the prediction model based on a specific type of information among the sequence-type text data of the content item obtained from the preprocessing unit 760. According to one embodiment, the first learning unit 770 may perform training on the prediction model based on hashtag information in the sequence-type text data of the content item. For example, the first learning unit 770 may perform learning on the language model based on hashtag information, as illustrated in FIG. 9A. That is, the first learning unit 770 may perform primary learning on the language model based on hashtag information using a hashtag prediction model 920, which is a prediction model of the MLM method. As another example, the first learning unit 770 may perform learning on the language model based on synopsis information, as illustrated in FIG. 9B. That is, the first learning unit 770 may perform learning on the language model based on synopsis information using a synopsis prediction model 960, which is a prediction model of the MLM method. The second learning unit 730 performs secondary learning on the language model using a prediction model configured to predict or infer masked tokens. That is, the second learning unit 730 performs secondary learning, which is additional learning, on a language model primarily learned by the first learning unit 720. The second learning unit 730 may perform secondary learning on the language model by performing additional training on the primarily learned language model based on other types of information that are not used in the primary learning among the sequence-type text data of content items acquired by the preprocessing unit 710 using the prediction model of the MLM method. According to one embodiment, when the primary learning is performed based on hashtag information, the secondary learning may be performed based on synopsis information in the sequence-type text data of the content item. For example, as illustrated in FIG. 9B, the second learning unit 780 may perform secondary learning on the language model based on synopsis information using the synopsis prediction model 960, which is a prediction model of the MLM method. According to one embodiment, when the primary learning is performed based on synopsis information, the secondary learning may be performed based on hashtag information in the sequence-type text data of the content item. For example, as illustrated in FIG. 9A, the second learning unit 780 may perform secondary learning on the language model based on hashtag information using the hashtag prediction model 920, which is a prediction model of the MLM method.

According to one embodiment, the second learning unit 780 may perform secondary learning using text metadata of content items used for learning of the first learning unit 770. According to one embodiment, the second learning unit 780 may select at least some content items having a type of information to be used for secondary learning among the content items used for learning of the first learning unit 770, and perform secondary learning using text metadata of at least some of the selected content items. For example, when hashtag information is used for secondary learning of the language model, the second learning unit 780 may select only content items having hashtag information among the content items used for learning of the first learning unit 770, and perform secondary learning using text metadata of the selected content items as a training data set for a prediction model. As another example, when synopsis information is used for the secondary learning of the language model, the second learning unit 780 may select only content items having synopsis information among the content items used for learning by the first learning unit 770, and perform secondary learning by using the text metadata of the selected content items as a training data set for the prediction model. However, this is only an example, and the training data set used for learning by the second learning unit 780 is not limited thereto.

In the description referring to FIG. 7B, the model learning unit 620 performs the primary learning based on hashtags using the prediction model of the MLM method and then performs the secondary learning based on synopsis, or performs the primary learning based on synopsis and then performs the secondary learning based on hashtags. However, the present disclosure is not limited thereto. That is, the model learning unit 620 may perform N-th learning using at least two types of information among various types of information included in the sequence-type text data of the acquired content item. For example, the model learning unit 620 may perform the primary learning based on synopsis or the primary learning based on hashtags using the prediction model of the MLM method and then perform the secondary learning based on genre using the prediction model of the text classification method. As another example, the model learning unit 620 may perform the primary learning based on genre using the prediction model of the text classification method, and then perform the secondary learning based on hashtags and the secondary learning based on synopsis using the prediction model of the MLM method. As another example, the model learning unit 620 may perform the primary learning based on synopsis using the prediction model of the MLM method, perform the secondary learning based on hashtags using the prediction model of the MLM method, and then perform tertiary learning based on genre using the prediction model of the text classification method.

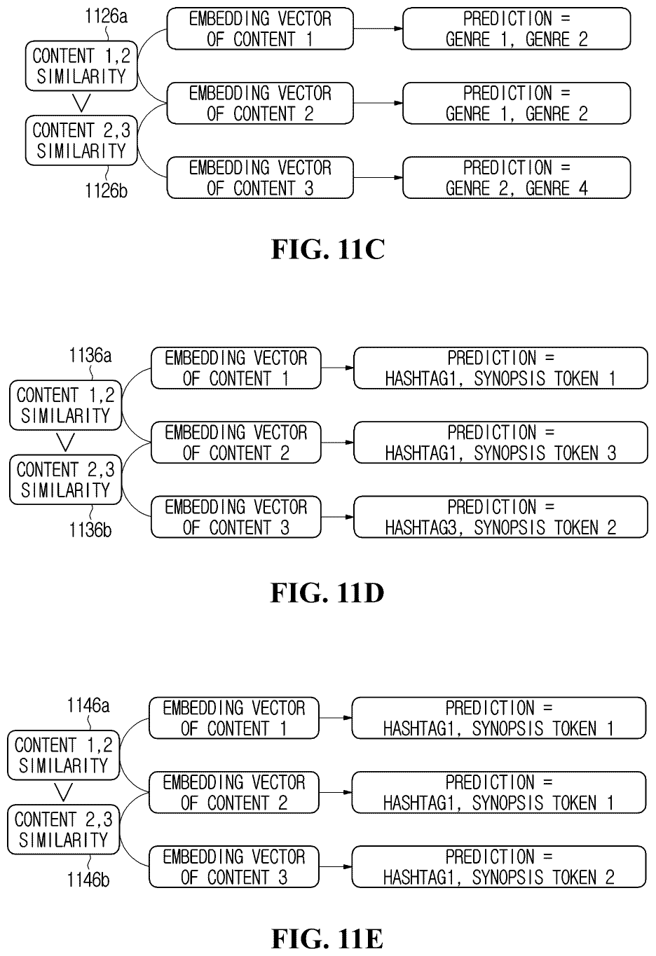

In the structure described above, the more accurately the prediction model infers the target, the more sophisticated the semantic representation of the language model becomes, and accordingly, the similarity between content items may be calculated more accurately. For example, as in FIG. 11A, when training or learning to predict a hashtag is performed, content items having the same prediction value in terms of the hashtag may be similarly embedded. FIG. 11A illustrates an example of a prediction value and similarity relationship of each content according to an embodiment of the present disclosure. Referring to FIG. 11A, the similarity 1106a between content 1 and content 2 having the same hashtag may be greater than the similarity 1106b between content 2 and content 3 having different hashtags.

For another example, as in FIGS. 11B and 11C, when performing training or learning to predict a genre, content items having the same prediction value in terms of the genre may be similarly embedded. FIG. 11B illustrates an example of a prediction value and similarity relationship of each content according to an embodiment of the present disclosure. FIG. 11B illustrates a case where the predicted genres of content 1 and content 2 are ‘genre l’ and the predicted genre of content 3 is ‘genre 2’. Referring to FIG. 11B, the similarity 1116a between content 1 and content 2 having the same predicted genre may be greater than the similarity 1116b between content 2 and content 3 having different predicted genres. FIG. 11C illustrates another example of a prediction value and similarity relationship of each content according to an embodiment of the present disclosure. FIG. 11C shows a case where the predicted genres of content 1 and content 2 are ‘genre 1’ and ‘genre 2’, and the predicted genres of content 3 are ‘genre 2’ and ‘genre 4’. Referring to FIG. 11C, the predicted genres of content 1 are the same as the predicted genres of content 2. On the other hand, the predicted genres of content 3 are partly the same as and partly different from the predicted genres of content 2. Therefore, the similarity 1126a between content 1 and content 2 having the same predicted genres may be greater than the similarity 1126b between content 2 and content 3 having partly different predicted genres.

For another example, when performing training or learning to predict hashtags and synopses, as in FIGS. 11D and 11E, content items having at least one of the prediction values in terms of the hashtags and/or synopses may be similarly embedded. FIGS. 11D and 11E illustrate examples of a prediction value and similarity relationship of each content according to an embodiment of the present disclosure. Referring to FIG. 11D, the similarity 1136a between content 1 and content 2 having the same hashtag may be greater than the similarity 1136b between content 2 and content 3 having different hashtags. However, when the hashtags of content 2 and content 3 have similar meanings, the similarity between content 2 and content 3 may be determined to be as high as the similarity between content 1 and content 2 having the same hashtag. For example, if the hashtag of content 2 is ‘exorcism’ and the hashtag of content 3 is ‘occult’, ‘exorcism’ and ‘occult’ are not composed of the same tag tokens, but since their meanings are similar, the similarity between content 2 and content 3 may be determined to be higher than the similarity in the case where they have different hashtags with different meanings. This is because the prediction model reflects context information based on the ‘mutual’ relationship between tokens in spatial learning. In other words, the prediction model may be learned to determine the contents as similar contents if their meanings are similar even if the tags of the contents are different. In other words, even if two contents have different hashtags, if the hashtags are semantically similar, the similarity between the two contents may be higher than the similarity between contents with semantically completely different hashtags. In addition, the similarity between two contents may be calculated to be a value that is as high as the similarity between contents with the same tag.

Referring to FIG. 11E, when content 1, content 2, and content 3 have the same hashtag, the similarity 1146a between content 1 and content 2 having the same synopsis token may be greater than the similarity 1146b between content 2 and content 3 having different synopsis tokens.

In the above description, the model learning unit 620 performs learning on the language model by training the prediction model of the MLM method based on hashtag information or synopsis information, or performs learning on the language model by training the prediction model of the text classification method based on genre information. However, the present disclosure is not limited thereto. According to one embodiment, the model learning unit 620 may perform learning on the language model by training the prediction model of the MLM method based on different types of information other than hashtag information and synopsis information, or by training the prediction model of the text classification method based on different types of information other than genre information. For example, the model learning unit 620 may perform learning on the language model by using other information that may reflect the user's content preference. [Table 5] below is an example of an expression for the user's preferred content.

TABLE 5

| Example of favorite movie expressions | Criterion classification |
|---|---|
| I like action movies. | Genre (action) |
| I like Japanese movies. | Hashtag (# Japanese |
| | background) |
| I like movies directed by director Hong | Director (Hong Gil-dong) |
| Gil-dong. | |
| I want to see a touching movie. | Hashtag (# touching) |
| I trust and watch actor Kim Gil-dong's movies. | Actor (Kim Gil-dong) |

[Table 5] shows that the user's preferred content may be reflected in the genre, hashtag, director, or actor information of the content. As shown in Table 5, the director or actor information is information that reflects the user's content preference. However, since there are many pieces of target information corresponding to the director or actor information, and it is rare for the contents to have the same director information or the same actor information, it is difficult to learn a generalized semantic representation for the director or actor information. On the other hand, the hashtag or genre information reflects the user's content preference, but compared to other features (e.g., director, actor), the target information is relatively small, and the contents often have the same genre and/or hashtag. In addition, the genre information appears in each individual data within a given category, and the main nouns corresponding to the hashtag information are learned a lot in the pre-learning stage. Therefore, it can be said that it is easy to learn a generalized semantic representation for the genre or hashtag information.

The similarity determination unit 630 may determine the similarity between content items using the language model learned by the model learning unit 620. The similarity determination unit 630 may obtain text metadata for each content item and convert the obtained text metadata into sequence-type text data. The similarity determination unit 630 may obtain vector values for each content item from the sequence-type text data obtained for each content item using the learned language model. In addition, the similarity determination unit 630 may determine the similarity between content items by comparing the vector values for each content item.

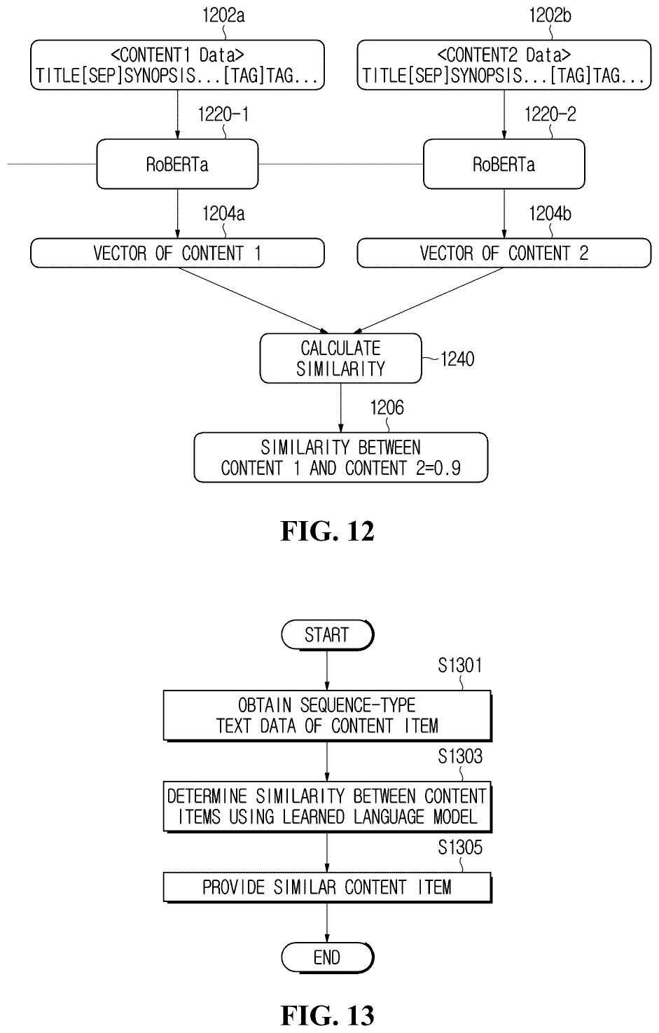

For example, the similarity determination unit 630 may determine the similarity, as illustrated in FIG. 12. FIG. 12 illustrates an example of calculating the similarity between contents using a language model learned according to one embodiment of the present disclosure. Referring to FIG. 12, the similarity determination unit 630 may obtain a vector 1204a of content 1 from <content 1 Data> 1202a, which is a sequence-type text data of content 1, using the RoBERTa model 1220-1, and may obtain a vector 1204b of content 2 from <content 2 Data> 1202b, which is a sequence-type text data of content 2, using the RoBERTa model 1220-2. Here, although two RoBERTa models 1220-1 and 1220-2 are expressed as being used, this is to emphasize that one vector is obtained for each content data, and the similarity determination unit 630 may repeatedly use one RoBERTa model or process it in parallel. That is, the two RoBERTa models 1220-1 and 1220-2 may be the same model. The similarity determination unit 630 may calculate the similarity between the vector 1204a of content 1 and the vector 1204b of content 2 by using the similarity calculation block 1240 that calculates the similarity between vectors. For example, the similarity calculation block 1240 may calculate the similarity based on a cosine similarity algorithm. The similarity between the vector 1204a of content 1 and the vector 1204b of content 2 may be interpreted as the similarity 1206 between content 1 and content 2.

According to one embodiment, the similarity determination unit 630 may determine a vector value for the sequence-type text data of the corresponding content by using the embedding values of the last hidden layer of the language model, excluding the MLM head layer from the prediction model used in the second learning unit 730 of the model learning unit 620. In other words, the model used for determining the similarity and the model used for fine-tuning may have different structures. That is, the model in the learning step for fine-tuning includes the MLM head layer for predicting the masked token, but the model in the step for determining the similarity may not include the MLM head layer and may further include a similarity calculation block.

The similarity determination unit 630 may obtain a vector of each content item, i.e., an input text vector to be used for similarity calculation, according to various embodiments. Embodiments for determining the input text vector are as follows.

According to one embodiment, a method using a pooler output may be applied. Specifically, when using a pooler output, the last hidden layer output vector of the [CLS] token of the language model is used as an input text vector.

According to one embodiment, a method using the average of the last hidden states values may be applied. When using the average of the last hidden states values, a vector obtained through average pooling for the last hidden layer output vector of all words of the language model is used as the input text vector.

According to one embodiment, a method of utilizing the maximum value of the last hidden state values may be applied. When using the maximum value of the last hidden state values, a vector obtained through max pooling for the last hidden layer output vector of all words of the language model is used as an input text vector.

Among the various embodiments described above, the similarity determination unit 630 may obtain an input text vector for similarity calculation according to a method using the average of the last hidden state values. This is because, based on the classification criteria of the similarity test set described below, the performance of the method using the average of the last hidden state values was confirmed to be the highest in the experimental results for the above-described methods. Specifically, when comparing the case of the method using the maximum value of the last hidden state and the case of the method using the pooler output with the method using the average of the last hidden state values, both the Type 1 accuracy and the Type 2 accuracy decreased. Here, the Type 1 accuracy means an accuracy calculated by determining that a correct judgment is made if the similarity between a reference content item and a similar content item is higher than the similarity between the reference content item and a less similar content item, and the Type 2 accuracy means an accuracy calculated by determining that a correct judgment is made if the similarity between a reference content item and a similar content item is higher than the similarity between the reference content item and a different content item.

Additionally, the similarity determination unit 630 may assign weights to the positions of specific features among the last hidden state values of the language model. Examples of assigning weights are as follows. In the following description, as an example to help understanding, it is assumed that a weight of 2 (e.g., 2 times) is applied, but the weight is not limited to 2. For example, the weight may be k, and k may be a real number greater than 1.

According to one embodiment, a method of assigning weights to hashtag values may be applied. In this case, vector values corresponding to tokens located between [TAG] and [/TAG], which are special tokens indicating the hashtag area among vector values of the last hidden layer, may be assigned a weight of double.

According to one embodiment, a method of assigning weights to genre values may be applied. In this case, a weight of double may be assigned to vector values corresponding to tokens located between [GENRE] and [/GENRE], which are special tokens indicating a genre area among vector values of the last hidden layer. For example, after average pooling for vector values corresponding to tokens, an average may be calculated again only for vectors located at the genre position, and then the average may be added to the average pooling result. However, embodiments of the present disclosure are not limited thereto. For example, during average pooling, a weight may be applied to each feature position, and a weighted average may be calculated.

According to one embodiment, a method of assigning weights to different types of features (e.g., title and hashtag values or synopsis and hashtag values) may be applied. For example, a method of assigning weights to title and synopsis values may be applied. In this case, a weight of double may be assigned to vector values corresponding to tokens located before and after [September] among vector values of the last hidden layer. As another example, a method of assigning weights to genre and hashtag values may be applied. In this case, a weight of double may be assigned to vector values corresponding to tokens located between [TAG] and [/TAG] and tokens located between [GENRE] and [/GENRE] among vector values of the last hidden layer.

As in the various embodiments described above, the similarity determination unit 630 may assign weights to vector values corresponding to the position of at least one type of feature among the vector values of the last hidden layer. After assigning weights, the similarity determination unit 630 may obtain an input text vector for similarity calculation by determining an average of the vector values of the last hidden layer.

According to one embodiment, if the language model is learned based on a genre prediction model, which is a text classification prediction model, genre values may not exist in the vector values of the last hidden layer. This is because there are no genre-related tokens in the input sequence-type text data input to the language model. In this case, among the weighting methods described above, the method of assigning weights to genre values will not be applied.

The content determination unit 640 may determine content items similar to the reference content item based on the similarity between the content items determined by the similarity determination unit 630. The content determination unit 640 may check the similarity between each content items and the reference content item and generate a content item list based on the similarity. For example, the content determination unit 640 may select a specified number of content items in descending order of similarity with the reference content item among the content items stored in the server 120 and generate a content list including the selected content items. That is, the content items included in the content list may be listed according to the similarity.

In the above description, the model learning unit 620 may add frequent words of the text metadata of the contents to the vocabulary dictionary of the basic language model and learn using the vocabulary dictionary to which the frequent words have been added. If the frequent words are added to the vocabulary dictionary, the frequent words may be recognized as a single token in the language model without being segmented. For example, frequent words indicating a major category genre may be added to the vocabulary dictionary. If the frequent words indicating a major category genre are added to the vocabulary dictionary, the frequent words indicating a major category genre are recognized as a single token in the language model, so that the length of the sequence that the language model may recognize increases and the performance can be improved.

In the above description, MLM was performed based on hashtag information because the experimental results showed that the performance was the highest when MLM was applied to hashtag information. In other words, MLM may be performed on other information in the text metadata of the content, but the performance may be lower than when MLM is performed based on hashtag information.

In the above-described embodiments, the model learning unit 620 was described as being included in the server 120. That is, the server 120 using the learned language model may perform learning on the language model. However, according to another embodiment, the learning on the language model may be performed by an entity other than the server 120. In this case, the model learning unit 620 may not be included in the server 120, and the server 120 may receive information about the learned language model from a third-party device, build a learned language model, and then determine the similarity between content items using the learned language model.

FIG. 13 illustrates an example of a procedure for recommending content using a learned language model according to an embodiment of the present disclosure. The operating entity of FIG. 13 may be the server 120 of FIG. 1.

Referring to FIG. 13, in step S1301, the server obtains sequence-type text data of a content item. The server may obtain text metadata for each content item and convert the obtained text metadata into sequence-type text data. That is, the server may obtain sequence-type text data by concatenating features included in the metadata of the content item with separators. For example, the separators may include at least one of a separator token or a special token (e.g., a genre token, a director token, an actor token, a hashtag token).

In step S1303, the server determines the similarity between content items using the learned language model. The server may obtain vector values for each content item from the sequence-type text data obtained for each content item using the learned language model based on the hashtags and synopses of the content items. The server may determine the similarity between content items based on the vector values for each content item. For example, the server may obtain a vector of first content by inputting the sequence-type text data of a first content item to the learned language model, and may obtain a vector of second content by inputting the sequence-type text data of second content item to the learned language model. The server may calculate the similarity between the two vectors using a similarity algorithm (e.g., a cosine similarity algorithm). The server may determine the calculated similarity as the similarity between the first content item and the second content item. Through this, the server may calculate the similarity between the reference content item and each of the other content items.

In step S1305, the server provides at least one similar content item. The server may determine at least one content item similar to the reference content item based on the similarity determined in step S1303. That is, the server may provide at least one content item similar to the reference content item based on the similarity between contents. For example, the server may select a specified number of content items in descending order of similarity with the reference content item or content items having a similarity greater than a threshold value among the content items it has. For example, the server may select a specified number of content items in descending order of similarity with the content item or content items having a similarity greater than a threshold value among candidate content items designated according to another criterion. Then, the server may generate a content list including information about the selected content items and provide the generated content list to the client device. In other words, the server may transmit the content list to the client device. At this time, the format of the specific content list may vary depending on the environment, service, etc. that provides similar content.

According to one embodiment, the server may pre-calculate and store the similarity between all content items it has. When a specified event occurs, the server may determine a reference content item, and generate and provide a content list based on the pre-calculated similarity between the reference content item and other content items. For example, the specified event may include at least one of a content list request event of a client device, or a recommended content request event of a client device. The listed events are only examples for understanding, and the specified event is not limited thereto. Here, the reference content item may be determined based on preferred content according to the consumption history of the client device and/or the user. The content list may include some content items that are relatively similar to the reference content item among the content items it has.

According to one embodiment, the server may pre-calculate vector values of all content items it has by using the pre-learned language model, and store the calculated vector values in the content vector DB 612. When a specified event occurs, the server may obtain vector values of the reference content item and other content items from the content vector DB 612, and determine the similarity of the content items based on the vector values of the reference content item and other content items.

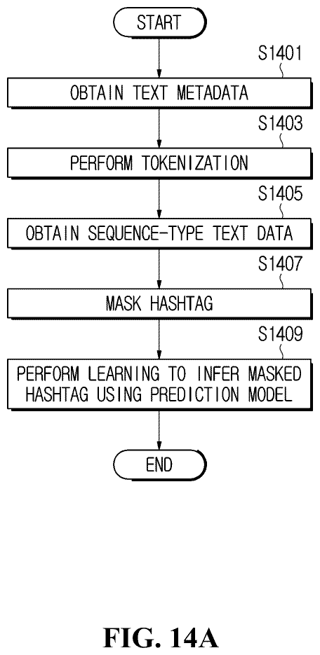

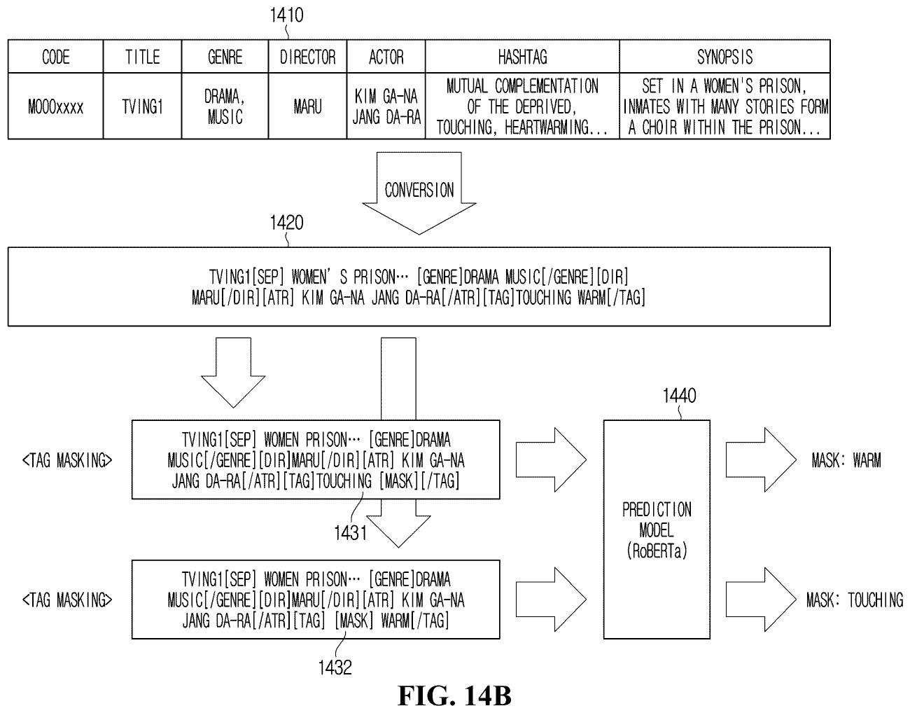

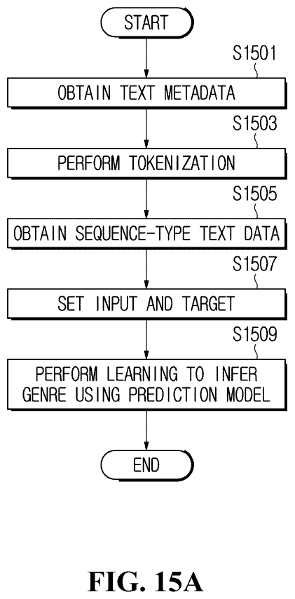

FIG. 14A illustrates an example of a procedure for performing learning on a language model according to an embodiment of the present disclosure. At least some of the operations of FIG. 14A below may be performed sequentially or in parallel. For example, some of the operations of FIG. 14A may be performed at least temporarily at the same time. Hereinafter, at least some of the operations of FIG. 14A will be described with reference to FIG. 14B. FIG. 14B illustrates an example of learning a language model using a language model according to an embodiment of the present disclosure.

Referring to FIG. 14A, in step S1401, the server obtains text metadata for the content. For example, as illustrated in FIG. 14B, the server may obtain text metadata 1410 including the title, genre, director, actor, hashtag, and synopsis of the content.

In step S1403, the server performs tokenization on the text metadata. For example, the server may utilize a byte pair encoding (BPE) algorithm or a morphological analyzer to separate the text metadata into token units. The byte pair encoding algorithm is an information compression algorithm that compresses data by merging the most frequently appearing strings in the target data, and may be composed of a vocabulary construction step and a tokenization step. Specifically, the byte pair encoding algorithm is an algorithm that merges strings that frequently appear in data, builds a vocabulary set by adding the merged strings to the vocabulary set, and then separates the subword from the word segment when each word segment in the target data contains a subword of the vocabulary set. The morphological analyzer is a technique that segments the target data into morphemes, which are the smallest semantic units.

In step S1405, the server obtains sequence-type text data. For example, the sequence-type text data may be obtained by adding at least one separator to data separated into token units. For example, the sequence-type text data may be determined as in FIG. 14B. The server may obtain sequence-type text data 1420 by separating metadata 1410 into tokens and inserting at least one separator token and at least a special token (e.g., a genre token, a director token, an actor token, a hashtag token, etc.) into the tokens.

In step S1407, the server masks the hashtag. The server may mask any one of the plurality of tokens located in the hashtag area. At this time, the hashtag area may be identified based on special tokens [TAG] and [/TAG] representing the hashtag. For example, referring to FIG. 14, the server may recognize that a “touching” token and a “warm” token exist between [TAG] and [/TAG] in the sequence-type text data 1420, and may replace the “warm” token with [MASK] 1431 or replace the “touching” token with [MASK] 1432. According to one embodiment, the server may mask a token that does not start with “#” among the plurality of tokens located in the hashtag area. Masking tokens that do not start with “#” is because tokens that contain core meaning, such as nouns and verbs, do not start with “#”.

In step S1409, the server performs learning to infer the masked hashtag using a language model-based prediction model. For example, as illustrated in FIG. 14B, if the “warm” token is masked, the server may be trained to infer the masked hashtag “warm” using the prediction model 1440, and if the “emotion” token is masked, the server may be trained to infer the masked hashtag “emotion” using the prediction model 1440. At this time, the prediction model 1440 may be learned by backpropagating a loss value to infer the masked hashtag. Through this, the parameters of the language model that derives the vector of each token in the prediction model 1440 may be updated so that the vectors of the tokens of the title and synopsis may reflect the semantic information of the masked hashtag.

The server may repeatedly perform steps S1407 and S1409 described above for multiple content items. In addition, the server may repeatedly perform steps S1407 and S1409 for the plurality of tokens within the hashtag area. In this way, when the random masking training method for multiple hashtag information is repeated, the parameters of the language model may be updated so that the semantic information of the multiple hashtags is reflected in the vectors of other tokens within the sequence-type text data. Accordingly, the language model may be trained to provide a more sophisticated semantic representation by a task of inferring masked tokens as illustrated in FIG. 14A, thereby better identifying similarities between contents.

In addition, as described above, the learned language model may return a vector containing information about hashtag features from other types of features (e.g., title, synopsis) in the sequence-type text data, even when there is a lack of or no hashtags in the sequence-type text data.

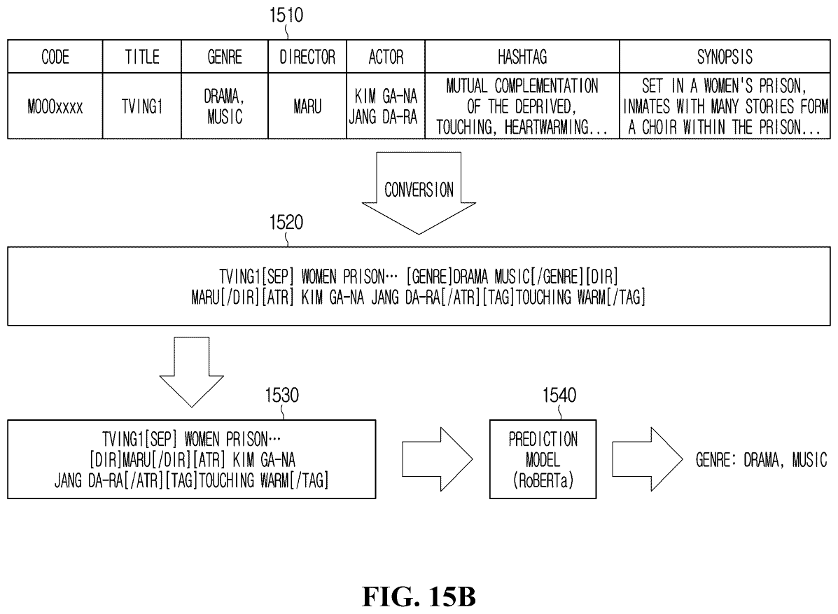

FIG. 15A illustrates an example of a procedure for performing learning on a language model according to an embodiment of the present disclosure. At least some of the operations of FIG. 15A below may be performed sequentially or in parallel. For example, some of the operations of FIG. 15A may be performed at least temporarily at the same time. At least some of the operations of FIG. 15A below will be described with reference to FIG. 15B. FIG. 15B illustrates an example of learning a language model using genre prediction according to an embodiment of the present disclosure.

Referring to FIG. 15A, in step S1501, the server obtains text metadata for content. For example, as illustrated in FIG. 15B, the server may obtain text metadata 1510 including the title, genre, director, actor, hashtag, and synopsis of the content.

In step S1503, the server performs tokenization on the text metadata. Tokenizing on the text metadata may be performed in the same manner as described in step S1403 of FIG. 14A.

In step S1505, the server obtains sequence-type text data. For example, the sequence-type text data may be obtained by adding at least one separator to data separated into token units. For example, the sequence-type text data may be determined as in FIG. 15B. The server may obtain sequence-type text data 1520 by separating metadata 1510 into tokens and inserting at least one separator token and at least a special token (e.g., a genre token, a director token, an actor token, a hashtag token, etc.) into the tokens.

In step S1507, the server sets the input and target of the prediction model. The server may obtain input sequence-type text data by removing genre-related tokens from the sequence-type text data, and set a target label based on the genre information token. For example, referring to FIG. 15B, the server may recognize that a “drama” token and a “music” token exist between [GENRE] and [/GENRE] in the sequence-type text data 1520, and set the input sequence-type text data 1520 from which these are removed as the input of the prediction model. In addition, the server may set a target label based on the “drama” token and the “music” token located between [GENRE] and [/GENRE] in the sequence-type text data 1520.

In step S1509, the server performs learning to infer a genre for input sequence-type text data using a language model-based prediction model. For example, as illustrated in FIG. 15B, the server may perform learning for the prediction model 1540 so that the genre for the input sequence-type text data 1530 is inferred as “drama” and “music.” At this time, the prediction model 1540 may be learned by backpropagating a loss value to infer a genre set as a target. Through this, parameters of the language model that derives the vector of each token in the prediction model 1540 may be updated so that the vectors of the tokens of the title, synopsis, and hashtag may reflect the semantic information of the genre token.

As described above, the learned language model may return a vector containing information about genre features from other types of features (e.g., title, synopsis) in the sequence-type text data, even if there is no genre information in the sequence-type text data.

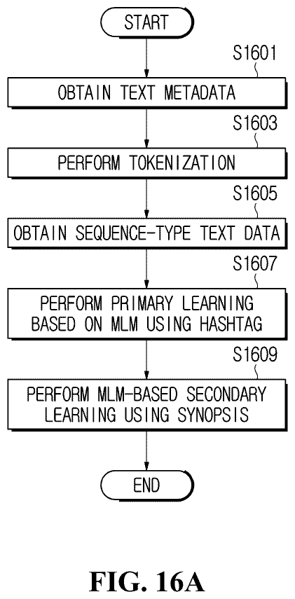

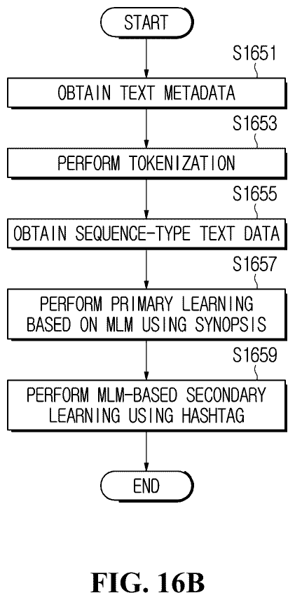

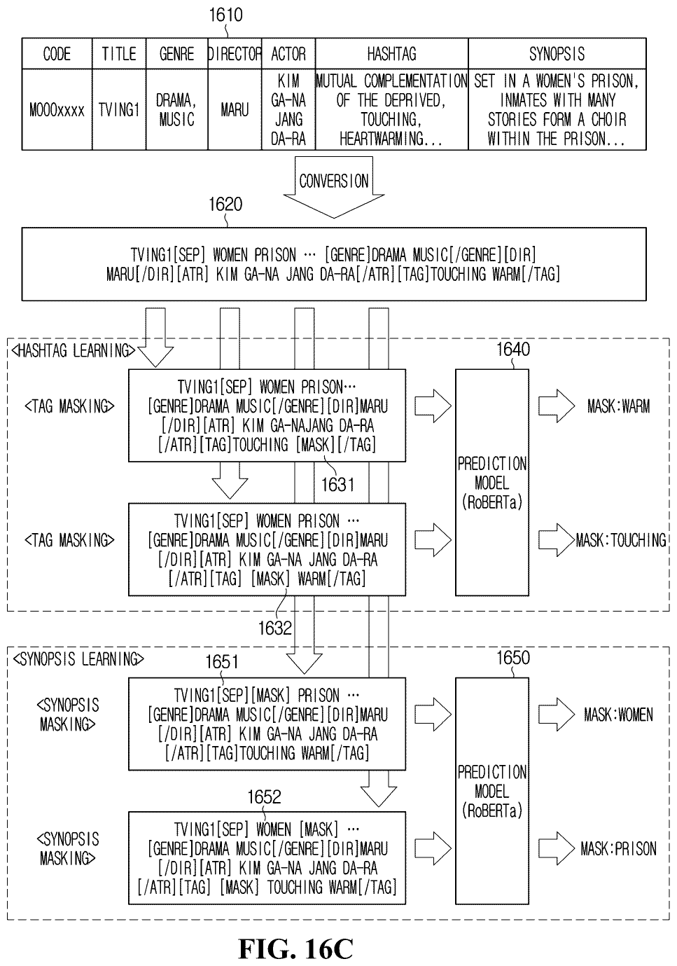

FIG. 16A illustrates an example of a procedure for performing learning on a language model according to an embodiment of the present disclosure. At least some of the operations of FIG. 16A below may be performed sequentially or in parallel. For example, some of the operations of FIG. 16A may be performed at least temporarily at the same time. At least some of the operations of FIG. 16A below will be described with reference to FIG. 16C. FIG. 16C illustrates an example of learning on a language model using a hashtag and a synopsis according to an embodiment of the present disclosure.

Referring to FIG. 16A, in step S1601, the server obtains text metadata for the content. For example, as illustrated in FIG. 16C, the server may obtain text metadata 1610 including the title, genre, director, actor, hashtag, and synopsis of the content.

In step S1603, the server performs tokenization on the text metadata. Tokenizing on the text metadata may be performed in the same manner as described in step S1403 of FIG. 14A.

In step S1605, the server obtains sequence-type text data. For example, the sequence-type text data may be obtained by adding at least one separator to data separated into token units. For example, the sequence-type text data may be determined as in FIG. 16C. The server may obtain sequence-type text data 1620 by separating metadata 1610 into tokens and inserting at least one separator token and at least a special token (e.g., a genre token, a director token, an actor token, a hashtag token, etc.) into the tokens.

In step S1607, the server performs MLM-based primary learning using hashtags. The server masks any one hashtag token among multiple hashtag tokens located in the hashtag area of sequence-type text data, and performs primary learning to infer the masked hashtag token using a language model-based prediction model. At this time, the hashtag area may be identified based on [TAG] and [/TAG], which are special tokens representing hashtags. For example, referring to FIG. 16C, the server recognizes that a “touching” token and a “warm” token exist between [TAG] and [/TAG] in the sequence-type text data 1620, and replaces the “warm” token with [MASK] 1631 or replaces the “touching” token with [MASK] 1632. According to one embodiment, the server may mask tokens that are not dependent tokens among the plurality of tokens located in the hashtag area. As illustrated in FIG. 16C, when the “warm” token is masked, the server may perform training on the prediction model 1640 to infer the masked hashtag token “warm,” and when the “touching” token is masked, the server may perform learning on the prediction model 1640 to infer the masked hashtag token “touching.” At this time, the prediction model 1640 may be learned by backpropagating a loss value to infer the masked hashtag token. Through this, the parameters of the language model that derives the vector of each token in the prediction model 1640 may be updated so that the vectors of the tokens of the title and the synopsis may reflect the semantic information of the masked hashtag. The server may obtain a primarily learned language model by repeating the hashtag masking and inference operations described above multiple times for multiple content items.

In step S1609, the server performs MLM-based secondary learning using synopsis. The server masks any one synopsis token among a plurality of synopsis tokens located in the synopsis area of the sequence-type text data, and performs secondary learning to infer the masked synopsis token using a language model-based prediction model. At this time, the synopsis area may be identified based on a separator token [September] and a special token [GENRE] for the genre area. For example, referring to FIG. 16B, the server recognizes that a “woman” token and a “prison” token exist between [September] and [GENRE] in the sequence-type text data 1520, and replaces the “woman” token with [MASK] 1651 or replaces the “prison” token with [MASK] 1652. According to one embodiment, the server may mask a token that is not a dependent token among a plurality of tokens located in the synopsis area. As illustrated in FIG. 16C, the server may perform learning on the prediction model 1650 to infer the masked synopsis token “woman” when the “woman” token is masked, and may perform learning on the prediction model 1650 to infer the masked synopsis token “prison” when the “prison” token is masked. At this time, the prediction model 1650 may include a language model primarily learned in step S1607, that is, a language model learned based on a hashtag. The prediction model 1650 may be learned by backpropagating a loss value to infer the masked synopsis token.

Through this, the parameters of the language model that derives the vector of each token in the prediction model 1640 may be updated so that the vectors of the tokens of the title, hashtag, or genre may reflect the semantic information of the masked synopsis token. The server may obtain a secondarily learned language model by repeating the synopsis masking and inference operations described above multiple times for multiple content items.

FIG. 16B illustrates an example of a procedure for performing learning on a language model according to an embodiment of the present disclosure. At least some of the operations of FIG. 16B below may be performed sequentially or in parallel. For example, some of the operations of FIG. 16B may be performed at least temporarily at the same time. At least some of the operations of FIG. 16B below will be described with reference to FIG. 16C.

Referring to FIG. 16B, in step S1651, the server obtains text metadata for the content. For example, as illustrated in FIG. 16C, the server may obtain text metadata 1610 including the title, genre, director, actor, hashtag, and synopsis of the content.

In step S1653, the server performs tokenization on the text metadata. Tokenizing on the text metadata may be performed in the same manner as described in step S1403 of FIG. 14A.

In step S1655, the server obtains sequence-type text data. For example, the sequence-type text data may be obtained by adding at least one separator to data separated into token units. For example, the server may obtain sequence-type text data 1620 as illustrated in FIG. 16C.

In step S1657, the server performs MLM-based learning using synopsis. The server masks any one synopsis token among multiple synopsis tokens located in the synopsis area of the sequence-type text data, and performs primary learning to infer the masked synopsis token using a language model-based prediction model. For example, the server may first perform synopsis learning to infer the masked synopsis using a prediction model 1650, as illustrated in FIG. 16C.

In step S1659, the server performs MLM-based learning using hashtags. The server masks any one hashtag token among multiple hashtag tokens located in the hashtag area of the sequence-type text data, and performs secondary learning to infer the masked hashtag token using a language model-based prediction model. For example, the server may perform hashtag learning to infer the masked hashtag token using a prediction model 1645, as illustrated in FIG. 16C. At this time, the prediction model 1645 may include a language model primarily learned by synopsis learning.

As shown in FIG. 16A and FIG. 16B described above, when the random masking training method for multiple hashtag tokens and multiple synopsis tokens is repeated, the parameters of the language model may be updated so that the semantic information of the multiple hashtag tokens and the semantic information of the multiple synopsis tokens are reflected in the vectors of other tokens in the sequence-type text data. Accordingly, the language model may be learned to provide more sophisticated semantic representations by the task of inferring masked tokens as illustrated in FIGS. 16A and 16B, thereby better identifying similarities between contents.

In addition, as described with reference to FIGS. 16A and 16B, the learned language model may return a vector containing information about a hashtag feature from other types of features (e.g., title, genre) in the sequence-type text data, even when there is a lack of or not hashtags or synopsis in the sequence-type text data.

FIG. 16A illustrates a procedure in which a server performs primary learning on a language model based on hashtag information using MLM, and then performs secondary learning on a language model based on synopsis, and FIG. 16B illustrates a procedure in which a server performs primary learning on a language model based on synopsis information using MLM, and then performs secondary learning on a language model based on hashtags. In general, hashtag information of content items includes information related to a user's content preference or information that may reflect the user's content preference, while synopsis information may include not only information related to the user's content preference but also information unrelated to the user's content preference. Therefore, the performance of the language model may vary depending on whether hashtag information or synopsis information is used first when learning the language model. Specifically, as shown in FIG. 16A, when a language model is learned based on synopsis information after being learned with hashtag information, the parameters of the language model may quickly converge to values close to the optimal values based on the hashtag information, and then be fine-tuned more based on the synopsis information. On the other hand, as shown in FIG. 16B, when first performing learning with the synopsis information among the hashtag information and synopsis information, overfitting of the learned language model can be prevented. Overfitting refers to a state in which a language model is overly adapted to learning data, resulting in deterioration in performance for data other than the learning data. In other words, since synopsis information includes information unrelated to the user's content preference, the overfitting phenomenon of the language model can be suppressed.

In the description referring to FIG. 16A and FIG. 16B, the language model is learned based on hashtag information and synopsis information in the metadata of content items, but other information may be used to learn the language model. For example, the language model may be primarily learned using hashtag information based on MLM, and then secondarily learned using genre information. As another example, the language model may be primarily learned using synopsis information based on MLM, and then secondarily learned using genre information.

Additionally, the language model may be learned using only synopsis information of content items based on MLM.

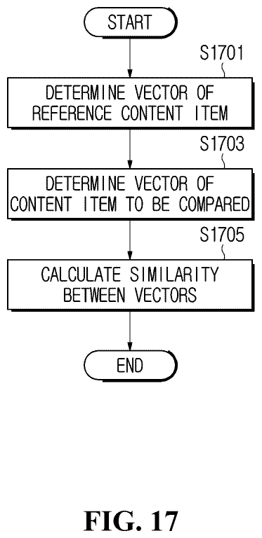

FIG. 17 illustrates an example of a procedure for determining the similarity of content using a learned language model according to an embodiment of the present disclosure. The operations of FIG. 17 are an example of operation S1303 of FIG. 13, and may be understood as a procedure for determining the similarity between two content items. At least some of the operations of FIG. 17 may be performed sequentially or in parallel. For example, some of the operations of FIG. 17 may be performed at least temporarily at the same time.

Referring to FIG. 17, in step S1701, the server determines a vector of a reference content item. Here, the vector may be determined based on sequence-type text data determined using text metadata. For example, the server may obtain text metadata of the reference content item, perform tokenization on the obtained text metadata, and then obtain sequence-type text data by inserting at least one separator. Then, the server may obtain a vector corresponding to the sequence-type text data of the reference content item using the learned language model. Specifically, the server may determine a vector, i.e., an embedding value, by inputting the sequence-type text data to the learned language model and obtaining output data of the language model. The learned language model may be a learned language model as described in FIG. 14A, FIG. 15A, FIG. 16A, or FIG. 16B. However, except for the head layer used when inferring tokens (e.g., hashtag tokens or synopsis tokens) or predicting classes in the language model for similarity calculation, the last hidden layer embedding value of the language model itself may be used as the embedding value for the text metadata of the content. At this time, according to one embodiment, the server may determine the vector of the content for similarity calculation by using any one of a method using pooler output, a method using an average of the last hidden state values, or a method using a maximum value of the last hidden state values. In addition, according to one embodiment, when determining the vector of the content for similarity calculation, the server may give weight to a value corresponding to the position of a specific feature among the last hidden state values.

In step S1703, the server determines a vector of the content item to be compared. Here, the vector may be determined based on sequence-type text data determined using text metadata. For example, the server may obtain text metadata of the content item to be compared, perform tokenization on the obtained text metadata, and then obtain sequence-type text data by inserting at least one separator. Then, the server may obtain a vector corresponding to the sequence-type text data of the content item to be compared using the learned language model. Specifically, the server may determine a vector, i.e., an embedding value, by inputting the sequence-type text data to the learned language model and obtaining output data of the language model. The learned language model may be a learned language model as described in FIG. 14A, FIG. 15A, FIG. 16A, or FIG. 16B. However, except for the head layer used when inferring tokens (e.g., hashtag tokens or synopsis tokens) or predicting classes in the language model for similarity calculation, the last hidden layer embedding value of the language model itself may be used as the embedding value for the text metadata of the content. At this time, according to one embodiment, the server may determine the vector of the content for similarity calculation by using any one of a method using pooler output, a method using an average of the last hidden state values, or a method using a maximum value of the last hidden state values. In addition, according to one embodiment, when determining the vector of the content for similarity calculation, the server may give weight to a value corresponding to the position of a specific feature among the last hidden state values.

In step S1705, the server may calculate the similarity between the content items. For example, the server may determine the similarity between the reference content item and the content item to be compared based on the cosine similarity algorithm. For example, the server may calculate the similarity between the vector of the reference content item and the vector of the content item to be compared, and determine the calculated similarity as the similarity between the reference content item and the content item to be compared.

In the above description, when the language model is learned based on the genre prediction model of the text classification method, in order to obtain a vector value for each content item for determining the similarity between content items, the input sequence-type text data from which the genre-related tokens have been removed is used as the input of the learned language model. However, the embodiments of the present disclosure are not limited thereto. For example, the server or the similarity determination unit 630 of the server according to the embodiment of the present disclosure may use the sequence-type text data including the genre-related tokens as the input of the learned language model. For example, the server or the similarity determination unit 630 of the server may input the sequence-type text data including the genre-related tokens as shown in [Table 1] to the learned language model to obtain a vector value for each content item, and then determining the similarity between the content items.

FIG. 18A illustrates an example of the structure of a transformer applicable to an embodiment of the present disclosure, and FIG. 18B illustrates an example of the detailed structure of encoder and decoder blocks of a transformer applicable to an embodiment of the present disclosure.

Referring to FIGS. 18A and 18B, the transformer 1800 may include N encoder blocks 1810-1 to 1810-N and N decoder blocks 1820-1 to 1820-N. Each of the N encoder blocks 1810-1 to 1810-N may include a self-attention block 1811 and a feed forward block (or neural network) 1813. Each of the N decoder blocks 1820-1 to 1820-N may include a self-attention block 1821, an encoder-decoder attention block 1823, and a feed forward block 1825.

The input of the transformer 1800 may be tokenized, embedded, added with a positional encoding vector, and then input to the first encoder block 1810-1 located at the bottom among the N encoder blocks 1810-1 to 1810-N. Each self-attention block 1811 of the N encoder blocks 1810-1 to 1810-N may determine a word to focus on among several input words. The self-attention block 1811 may multiply the input embedding vector by three learnable matrices, respectively, to generate a query vector, a key vector, and a value vector. The self-attention block 1811 may be a multi-headed attention block having multiple attention heads and representing each vector in a different representation space for each purpose using multiple query vectors, key vectors, and value vectors. The output of the self-attention block 1811 may pass through the neural network of the feed forward block 1813 and be input to the next encoder block (e.g., the second encoder block 1810-2).

The output of the N-th encoder block 1810-N located at the top among the N encoder blocks 1810-1 to 1810-N may be a key vector and a value vector, which are attention vectors, and these may be input to the encoder-decoder attention block 1823 of each of the N decoder blocks 1820-1 to 1820-N.

The previous output of the transformer 1800 may be used as an input of the first decoder block 1820-1 located at the bottom among the N decoder blocks 1820-1 to 1820-N. For example, the previous output of the transformer 1800 may be tokenized, embedded, added with a positional encoding vector, and then input to the first decoder block 1820-1.

The self-attention block 1821 of each of the N decoder blocks 1820-1 to 1820-N is similar to the self-attention block 1811 of each of the N encoder blocks 1810-1 to 1810-N. However, the self-attention block 1821 of each of the N decoder blocks 1820-1 to 1820-N differs from the self-attention block 1811 of each of the N encoder blocks 1810-1 to 1810-N in that it performs masking so that it may only attend to positions previous to the current position within the output sequence.

Each encoder-decoder attention block 1823 of the N decoder blocks 1820-1 to 1820-N may generate an output by taking as input a query vector output from the self-attention block 1821 and the key vector and the value vector output from the N-th encoder block 1810-N.

The output vector of the N-th decoder block 1820-N located at the top among the N decoder blocks 1820-1 to 1820-N may be input to a linear layer 1830 and a softmax layer 1840. The linear layer 1830 and the softmax layer 1840 may change the output vector of the N-th decoder block 1820-N to a single word. The linear layer 1830 is configured as a fully-connected neural network and may project the output vector of the N-th decoder block 1820-N into a logit vector, which is a vector with a larger size. Each cell of the projected logit vector may have a score for each corresponding word. The softmax layer 1840 may convert the scores of each cell into a probability. The transformed probability values of each cell all have positive values, and the sum of each probability value may be 1. At this time, the word corresponding to the cell with the highest probability value may be output as the final result of the softmax layer 1840. The output of the softmax layer 1840 may be re-embedded and added to the positional encoding vector, and then input to the first decoder block 1820-1 located at the bottom.

Sub-blocks included in each of the N encoder blocks 1810-1 to 1810-N and the N decoder blocks 1820-1 to 1820-N may be connected in a residual connection manner, and a layer-normalization (or Add & normalize) block may be included between each of the sub-blocks. The layer-normalization block may combine the input and output of the self-attention blocks 1811 and 1821 to prevent excessive data change in one layer.

The transformer 1800 is a neural network that learns the context and meaning of a sentence by tracking the relationship between words in the sentence, and may mathematically find patterns between elements without a labeled data set. Therefore, the transformer 1800 does not require a process of generating a data set, and may be fast because it is suitable for parallel processing.

RNN (Recurrent Neural Network) has been widely used in the field of natural language processing because it may have position information of each word due to its characteristic of sequentially receiving and processing words according to the positions of the words. However, RNN has the problem of being difficult to process in parallel and having long-term dependency. On the other hand, the transformer may capture the dependency between input and output by using the attention mechanism instead of RNN. In addition, the transformer applies attention to the position of each word in the encoder block during learning, that is, emphasizes the value that is most closely related to the query, and uses the masking technique in the decoder block, so parallel processing is possible.

The sizes of the encoder/decoder input/output of the transformer, the number of encoders/decoders, the number of attention heads, and/or the size of the hidden layer of the feed-forward neural network are hyperparameters that may be changed by the user.

The BERT model is a transformer-based language model as described above, and may be used by replacing or deleting some components of the transformer. FIG. 19 illustrates an example of the structure of a BERT model applicable to an embodiment of the present disclosure. For example, the BERT model may be a model that uses encoder blocks 1810-1 to 1810-N except for decoder blocks 1820-1 to 1820-N in the transformer, as illustrated in FIG. 19.

In the BERT model, a [CLS] token may be placed at the beginning of an input sentence, and a [September] token may be used at the end of the sentence to separate the sentences. The output embedding after the BERT operation may be an embedding that takes into account all the contexts of the sentence. For example, [CLS] is a simple embedding vector that has passed the embedding layer when inputting BERT, but when it passes through the BERT model, it may become a vector with context information that takes into account all the word vectors in the sentence.

Natural language processing using a transformer-based model such as the BERT model may be performed in two steps. The two steps may include a pre-training step in which a giant encoder embeds input sentences to model a language, and a step of fine-tuning a model learned through pre-training to perform various natural language processing tasks.

The BERT model is a pre-trained model, and since it performs pre-training embedding before performing a specific task, it is receiving attention as a model that can further improve the performance of the task than existing embedding technologies. In the modeling process that applies the BERT model, pre-training is performed in an unsupervised learning manner, and the encoder embeds a large corpus, transfers it, and performs fine-tuning to perform learning suitable for the purpose, thereby performing the task. Another feature of the BERT model is that it considers the context before and after the sentence by applying a bidirectional model, so it can show higher accuracy than before.

As described above, the language model learned according to the embodiment of the present disclosure acquires a vector of content by comprehensively considering not only the hashtag information and the synopsis information, but also the semantic information and/or the context information of other types of features, and calculates the similarity between the contents based on the vector. Therefore, the method of determining the similarity between the contents based on the language model according to the embodiment of the present disclosure may be said to be different from simply filtering the contents having similar hashtags and synopses.

In the present disclosure, similarity is not an absolute concept but a relative concept, so a test set for verifying the performance of the language model should reflect the relative concept well. The meaning of not being an absolute concept is that it is impossible to determine whether two contents are similar by comparing them alone. Therefore, in the present disclosure, in order to reflect the relative concept of similarity, a method of classifying the similarity between contents through a three-way comparison using three contents was designed. For example, when the similarity of the content that is more similar to the reference content among the three contents is higher than the similarity of the content that is less similar to the reference content, it is determined that the similarity has been accurately determined. In the present disclosure, in order to improve the accuracy of the test set while supplementing the relative concept of similarity, only objective cases judged identically by three or more multiple reviewers were used as the test set. This is to exclude as much as possible the subjectivity of the reviewer who places weight on a specific feature when judging the similarity of the contents. In the embodiment of the present disclosure, the similarity comparison criteria were constructed as easy and difficult criteria. This is to consider from various perspectives, as the performance improvement of difficult criteria may not necessarily be proportional to the performance improvement of easy criteria depending on the model.

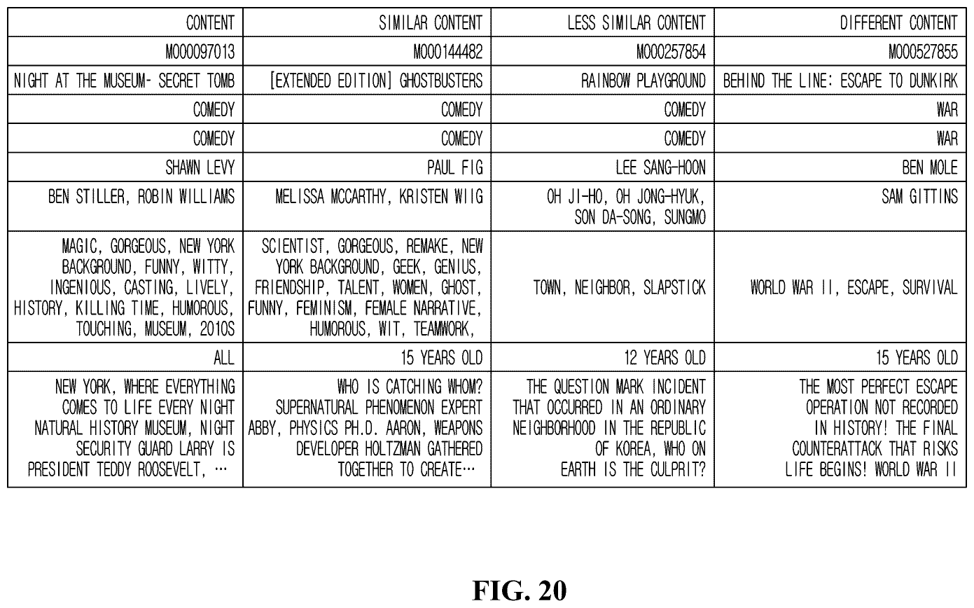

Specifically, based on the criteria for the similarity test set as follows, a test set as illustrated in FIG. 20 was designed. FIG. 20 illustrates an example of a test set according to an embodiment of the present disclosure.

### 1. Similarity Test Set Criteria

a. Similar content: Content that has genres and hashtags in common with the genres and hashtags of the reference content is considered similar content.

b. Less similar content: Content that has a genre similar to the genre of the reference content, but has hashtags that do not have anything in common with the hashtags of the reference content is considered less similar.

c. Different content: Content whose genre and hashtags do not have anything in common with the genre and hashtags of the reference content is considered different content.

In addition to the genre and hashtags described above, the similarity of the content was determined by basically considering the contents of the title and synopsis.

### 2. Similarity Test Set Classification

a. Classification accuracy 1: If the similarity between the reference content and similar content is higher than the similarity between the reference content and less similar content, it is judged that the similarity is determined accurately.

b. Classification accuracy 2: If the similarity between the reference content and similar content is higher than the similarity between the reference content and different content, it is judged that the similarity is determined accurately.

In the embodiment of the present disclosure, in order to determine the generalization performance of the prediction model, the ratio of data splitting was adjusted and the performance of multiple test sets was acquired and analyzed. When learning the prediction model, the size of the test set was set based on the number of new contents to be input into the prediction model within the training cycle (e.g., about one week) for the training set, validation set, and test set.

It may be different for each actual system, but it is assumed that the number of new contents to be input to the prediction model during the training period is expected to be about 100. Under this assumption, 100 cases were assigned to the test set and the verification set, and the remaining data were assigned to the training set. As described above, the data were randomly divided and the process of analyzing the test set performance was repeated several times. This is because more precise generalization performance can be identified when performing multiple performance analyses using various test sets rather than a single performance analysis. [Table 6] below shows the results of comparing the hashtag learning performance of each hashtag by dividing the training set, verification set, and test set through three rounds of random sampling.

TABLE 6

| Model type | Test set accuracy 1 | Test set accuracy 2 |
|---|---|---|
| Base language model | 78.16% | 88.51% |
| Prediction model 1st | 90.23% | 98.28% |
| Prediction model 2nd | 91.38% | 97.70% |
| Prediction model 3rd | 91.38% | 97.70% |

Referring to [Table 6], the prediction model showed performances of 90.23% to 91.38% and 97.7% to 98.28% in terms of similarity test set accuracy 1 and accuracy 2, respectively. Compared to the performances of the basic language model before learning through hashtag prediction, which were 78.16% and 88.51%, they improved by approximately 12% and 9%, respectively. [Table 7] below shows the results of comparing the learning performance of each genre by dividing the training set, validation set, and test set through three rounds of random sampling.

TABLE 7

| | Test set | Test set |
|---|---|---|
| Model type | accuracy 1 | accuracy 2 |
| Base language model | 78.16% | 88.51% |
| Major category genre prediction model | 83.50% | 96.12% |
| Minor category genre prediction model | 83.50% | 96.12% |

Referring to [Table 7], the prediction model showed performances of 83.50% and 96.12% in terms of similarity test set accuracy 1 and accuracy 2, respectively. Compared to the performances of the basic language model before learning through genre prediction, which were 78.16% and 88.51%, these improved by approximately 5% and 8%, respectively. Referring to [Table 6] and [Table 7], it can be seen that the learning method of the prediction model significantly improves the ability to distinguish similar content based on content text metadata.

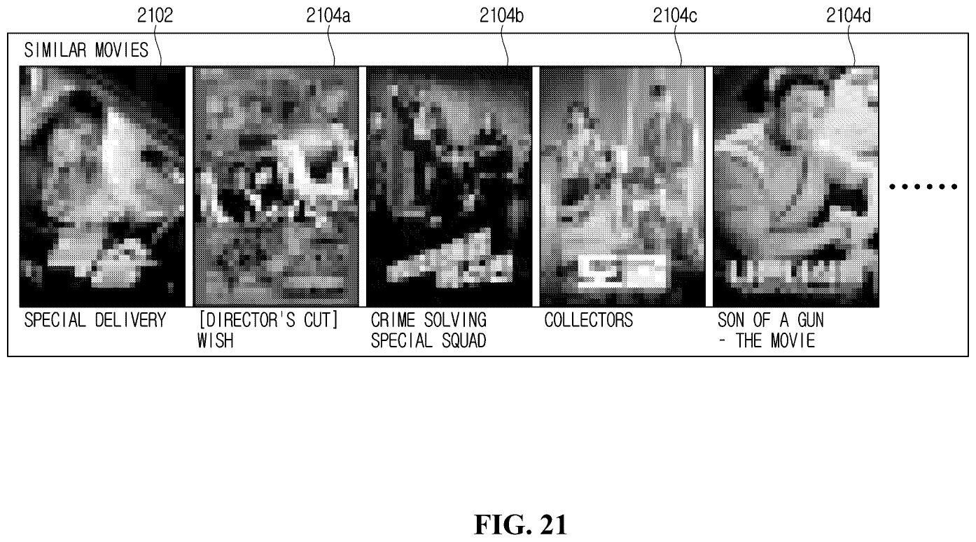

As described above, the similar content determination technique using the language model learned according to the embodiments of the present disclosure may be utilized in various ways. For example, when a reference content item is specified, a similar content list such as FIG. 21 may be provided. FIG. 21 illustrates an example of utilization of similar content determined according to an embodiment of the present disclosure. Referring to FIG. 21, when a reference content item 2102 is specified, a plurality of content items 2104a, 2104b, 2104c and 2104d similar to a reference content item 2102 are determined, and a list including the reference content item 2102 and the plurality of similar content items 2104a, 2104b, 2104c and 2104d may be provided. The provided list may be displayed on a client device. At this time, similar multiple content items 2104a, 2104b, 2104c and 2104d may be sorted in descending order of similarity with the reference content item 2102. That is, the first similar content item 2104a displayed closest to the reference content item 2102 may have a greater similarity than other content items 2104b, 2104c and 2104d. For example, the reference content item 2102 may be a content item recently viewed by the user or a content item specified by the user.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e.g., operating systems, applications, firmware, programs, etc.) that allow an operation according to a method of various embodiments to be performed on a device or computer, and a non-transitory computer-readable medium in which such software or commands are stored and executed on the device or computer.

What is claimed is:

1. A method of operating a server in a content streaming system, the method comprising:
obtaining first sequence-type text data including information included in first metadata of a first content item;
obtaining second sequence-type text data including information included in second metadata of a second content item;
determining a first vector corresponding to the first sequence-type text data and a second vector corresponding to the second sequence-type text data using a language model learned based on synopsis information included in metadata of content items;
determining a similarity between the first content item and the second content item using the first vector and the second vector; and
providing a content list including at least one content item including the second content item selected based on the similarity.

2. The method of claim 1, wherein the language model is learned through training to predict synopsis information of the content items based on a masked language model (MLM).

3. The method of claim 2, wherein the language model is primarily learned through training to predict hashtag information of the content items based on the MLM and is secondarily learned through training to predict synopsis information of the content items based on the MLM.

4. The method of claim 2, wherein the language model is primarily learned through training to predict synopsis information of the content items based on the MLM and is secondarily learned through training to predict hashtag information of the content items based on the MLM.

5. The method of claim 1, wherein the language model is learned through training to predict a masked token located between tokens indicating a synopsis area among a plurality of tokens included in input sequence-type text data.

6. The method of claim 5, wherein tokens indicating the synopsis area includes at least one of a separator token for separating different types of features or a special token for different types of features other than the synopsis.

7. The method of claim 5, further comprising:
converting text metadata describing contents of the content items into the sequence-type text data;
masking a synopsis token located between tokens indicating the synopsis area among a plurality of tokens included in the sequence-type text data; and
performing learning on the language model through training to predict the masked synopsis token,
wherein the text metadata includes at least one of title, synopsis, genre, director, actor or hashtag information.

8. The method of claim 7, wherein the converting the text metadata into the sequence-type text data comprises:
dividing the text metadata into a plurality of tokens; and
generating the sequence-type text data by inserting at least one separator between the tokens,
wherein the at least one separator further includes at least one of tokens indicating the synopsis area, a separator token for separating different types of features, or special tokens indicating an area of a specific type of feature.

9. The method of claim 7, wherein the masking the synopsis token comprises:
selecting an independent token from among synopsis tokens located between tokens indicating the synopsis area; and
masking the selected independent token,
wherein the independent token is a token that does not start with a specified symbol.

10. The method of claim 7,
wherein the training is performed using a prediction model, and
wherein the prediction model includes the language model that receives, as input, sequence-type text data including the masked synopsis token and outputs vector values corresponding to the sequence-type text data, and a masked language model (MLM) head layer configured to predict at least one input token corresponding to at least one vector value output from the language model.

11. The method of claim 1, wherein the determining the similarity between the first content item and the second content item comprises calculating a similarity between the first vector and the second vector using a cosine similarity algorithm,
wherein each of the first vector and the second vector is obtained by performing average pooling for output vector values of a last hidden layer of the learned language model.

12. The method of claim 11, wherein each of the first vector and the second vector is determined by assigning a weight to a vector value corresponding to a position of a specified feature among the output vector values of the last hidden layer of the learned language model.

13. The method of claim 11, further comprising:
obtaining third sequence-type text data including information included in third metadata of a third content item;
determining a third vector corresponding to the third sequence-type text data using the learned language model; and
determining a similarity between the first content item and the third content item using the first vector and the third vector,
wherein the providing the content list comprises:
selecting the second content item from among the second content item and the third content item based on the similarity between the first content item and the second content item and the similarity between the first content item and the third content item.

14. A server in a content streaming system, the server comprising:
a communication unit configured to transmit and receive signals to and from at least one client device; and
a processor electrically connected to the communication unit,
wherein the processor is configured to:
obtain first sequence-type text data including information included in first metadata of a first content item;
obtain second sequence-type text data including information included in second metadata of a second content item;
determine a first vector corresponding to the first sequence-type text data and a second vector corresponding to the second sequence-type text data using a language model learned based on synopsis information included in metadata of content items;
determine a similarity between the first content item and the second content item using the first vector and the second vector; and
provide a content list including at least one content item including the second content item selected based on the similarity.

15. A program stored in a recording medium to execute the method according to claim 1 when operated by a processor.
